(19) United States
(12) Patent Application Publication
(10) Pub. No.: US 2016/0062586 A1
(43) Pub. Date: Mar. 3, 2016

(54) OVERLAP-FREE POSITIONING OF GRAPHICAL OBJECTS, IN PARTICULAR FOR KNOWLEDGE QUANTIFICATION

(71) Applicant: Quizista GmbH, Germering (DE)

(72) Inventor: Florian MÜLLER, Germering (DE)

(21) Appl. No.: 14/520,370

(22) Filed: Oct. 22, 2014

Related U.S. Application Data
(63) Continuation-in-part of application No. PCT/EP2014/068062, filed on Aug. 26, 2014.

(51) Int. Cl. G06F 3/0486; G06F 3/0482; G06F 3/0484; G06F 3/0488

(52) U.S. Cl. CPC G06F 3/0486; G06F 3/0488; G06F 3/0482; G06F 3/04842

(57) ABSTRACT

The present invention relates to a computer-implemented method for processing drag-and-drop gestures on a user interface, the method comprising the steps of displaying a plurality of graphical objects (M0-M8) on the user interface, at least two of said graphical objects (M0-M8) each being associated with a data structure, at least two of said data structures being associated with a model answer of an automated knowledge quantification system, detecting a drag-and-drop gesture on the user interface indicating that a first one of the plurality of graphical objects is moved to a line comprising at least a second one of the plurality of graphical objects, determining that the horizontal position of the first graphical object is in conflict with the at least one second graphical object, and moving the at least one second graphical object to the left to create sufficient space for the first graphical object.

### 1. RELATED APPLICATION

This application is a Continuation-in-Part (CIP) of PCT Patent Application No. PCT/EP2014/068062 filed Aug. 26, 2014, the contents of which are incorporated herein by reference in their entirety.

### 2. TECHNICAL FIELD

The present invention generally relates to methods and systems for processing drag-and-drop gestures on a user interface. More specifically, aspects of the present invention provide techniques for an overlap-free positioning of graphical objects, which is particularly suitable for use in automated knowledge quantification systems.

### 3. BACKGROUND

Programmable electronic devices are capable of, and frequently used for, automated knowledge assessment, where typically a set of objectively validatable answers to a question can be predefined.

Computer-implemented knowledge assessment is in many aspects superior over knowledge assessment based on human interaction, since it provides among others the advantages described in the following. Computing devices are available to a user 24 hours a day, seven days a week, which leads to an improved availability of correspondingly implemented knowledge assessment techniques. Questions and potentially also accompanying information may be enriched with multimedia, leading to an improved usage. Programmable devices using a hardware and/or software timer are capable of a more precise and objective measurement and limitation of the time which passes between outputting a question and submission of an answer for validation, and of calculating instantly upon receipt of an answer a (multifactorial) score, e.g. taking into consideration a diversity of factors (such as, without limitation, response times, the number of failed attempts, and the difficulty level of a question). Computing devices can select questions based on entirely objective criteria.

Various techniques for computer-aided knowledge assessment are known. For example, EP 2 228 780 A1 and US 2010/227305 A1 relate to a knowledge assessment tool for processing and managing test data, randomly selecting test questions, and storing test results in a database. U.S. Pat. No. 8,465,288 B1 relates to an individual characterization involving an age appropriate ability score, an aptitude score, and an innate and cognizant ability score. U.S. Pat. No. 8,356,997 B1 relates to a competency record comprising a set of data indicating a given student's knowledge in a plurality of competencies. U.S. Pat. No. 6,318,722 B1 relates to a word puzzle game in which clues and answers are hidden and exposed. US 2012/0178073 A1 relates to game systems with interoperating or both interoperating and interrelated quizzes and/or puzzles, whereby the solution to one question represents a clue helping the user in solving part of a subsequent word puzzle. WO 2007/007201 A2 and WO 2006/000632 A2 provide further technical background information about computer-implemented knowledge assessment techniques.

### 4. SUMMARY OF THE INVENTION

One particular disadvantage of many of the known techniques is that the assessment of whether a user knows a given set of facts concerning item relationships is conducted sequentially, i.e., the user is required to answer a series of questions about item relationships one question at a time. For example, the user would be required to separately state the country in which each of a plurality of mountains is located, or to separately answer questions concerning particular predecessors and successors of a political office-holder. Sufficient screen space provided, it is, however, preferable to enable users to modify, by means of repositioning graphical objects on a display, the assignment to a group or ranking of any item (of a plurality of items) at any time prior to collective submission for evaluation of a plurality of choices made.

To the extent that any known techniques, including drag-and-drop technologies from outside the field of knowledge quantification, enable the collective submission of a plurality of choices concerning item relationships, their user interfaces have disadvantages, in connection with knowledge quantification and certain other fields of use, with respect to either flexibility (in terms of the user's freedom to place items in different positions) or efficiency (in terms of the use of screen resources and processing time), as will be described in the following:

One common technique for assigning an item to a group with a drag-and-drop interface is to drag an item over to a container (such as a window) of another group and to drop it within the boundaries of that container. For example, a movable graphical object representing a file can be moved from one folder on a storage medium to another by dragging it from the window displaying the content of one container to the window displaying the content of another container. Similarly, items can also be dropped on target icons such as folder icons.

Drag-and-drop interfaces of the above-mentioned kind are, however, not optimized for the specific needs of such fields as knowledge quantification. For example, a file dropped into a directory folder will disappear from the window on which the operation is performed, requiring a more space-consuming multi-window display to keep track of the content of all containers. This has the further effect that items accidentally dropped in the wrong container can usually not be immediately moved from the wrong container to a different one without previously opening the original target container. However, in certain fields such as knowledge quantification, it is desirable to ensure the simultaneous display of all movable graphical objects and to minimize the number of user interface actions a user must perform to reassign an item to a different group.

Furthermore, known drag-and-drop interfaces of the above-mentioned kind typically require each item to be contained by a container, such as a window, at any given point in time (except, possibly, during drag-and-drop operations). However, in certain fields such as knowledge quantification, it is desirable in certain ways to have a containerless space in which items are kept so as to indicate that they are not presently a member of any particular group.

Other known drag-and-drop interfaces enable the user to order items. For example, the layout section of the user interface of Google's Blogger website (www(dot)blogger(dot)com) enables, through a drag-and-drop interface, the modification of the vertical order in which certain components appear on a web page. Using this interface, the user can pick up an object and place it in a different slot. A further example is LinkedIn (www(dot)linkedin(dot)com), which provides a similar drag-and-drop interface with a two-dimensional (multiple rows, two columns) list of items. A Blogger/LinkedIn-style drag-and-drop interface as described above enables the user to indicate an order of a plurality of items (in this case, a desired order; in connection with knowledge quantification, the order would be a presumed order to be subsequently evaluated for accuracy).

However, such an interface has flexibility and efficiency shortcomings. Each item in such an interface fills the same amount of screen space regardless of the actually-required space. The number of slots in which an item can be placed is identical to the number of items without allowing a more free-form placement of items in different positions. For example, a user of such an interface cannot elect to open a separate line of items because the number of lines is predetermined and static.

It is therefore one technical problem underlying aspects of the present invention to provide methods and systems which enable users to indicate, by means of repositioning graphical objects on a display, the assignment to a group and/or ranking of each of a plurality of items and to modify such choices at any time prior to collective submission for evaluation of a plurality of choices made, while striking a balance between the user's flexibility (in terms of the user's freedom to place items in different positions) and efficiency (in terms of the use of screen resources and processing time), thereby at least partly overcoming the above-mentioned disadvantages. It is another technical problem underlying aspects of the present invention to provide methods and systems capable of interpreting and evaluating the user's positioning of graphical objects in ways that result in an automated yet precise and differentiated quantification of a user's knowledge.

This problem is according to one aspect of the invention solved by a computer-implemented method for processing drag-and-drop gestures on a user interface. In the embodiment of claim 1, the method comprises the following steps:
a. displaying a plurality of graphical objects on the user interface, at least two of said graphical objects each being associated with a data structure, at least two of said data structures being associated with a model answer of an automated knowledge quantification system;
b. detecting a drag-and-drop gesture on the user interface indicating that a first one of the plurality of graphical objects is moved to a line comprising at least a second one of the plurality of graphical objects;
c. determining that the horizontal position of the first graphical object is in conflict with the at least one second graphical object; and
d. moving the at least one second graphical object to the left to create sufficient space for the first graphical object.

Accordingly, the invention incorporates some of the elements found in known drag-and-drop interfaces, including, by way of example and without limitation, movable graphical objects associated with data structures and displayed on a screen or part thereof as well as the detection of gestures representing the actions of picking up, moving, and/or dropping the movable graphical objects, and the repositioning of movable graphical items in response to drag-and-drop gestures.

Certain drag-and-drop gestures have emerged as a de-facto user interface standard. Movable graphical objects are commonly picked up by keeping a (typically the left) mouse button down or a finger on the touchscreen, in each case at least in part within the boundaries of the movable graphical object to be dragged, while moving around; and they are commonly dropped by releasing the mouse button or removing the finger from the touchscreen. The invention is, however, not tied to any particular gesture or set of gestures.

Examples of associated data structures include, by way of example and without limitation, text strings, numbers, images, audio segments, video clips, files, databases, data sets of databases, data sets such as postal addresses and user records, URLs, HTML pages, and XML objects.

The invention builds on such elements of known drag-and-drop interfaces and provides optimizations and functional enhancements, some of which are specific to the field of use of knowledge quantification.

In particular, the invention detects when a user has moved a first graphical object onto a line on which already one or more second graphical objects are located. If it is determined that the horizontal position of the first (moved) graphical object is in conflict with the one or more second (existing) objects on the target line, e.g. because the first graphical object is moved so that it overlaps one or more of the existing graphical objects, or because a minimal horizontal gap between the graphical objects cannot be maintained, the method moves at least one of the existing (second) graphical objects to the left in order to create sufficient space for the moved (first) graphical object.

This way, the invention optimizes, in response to user gestures, the simultaneous display of a plurality of graphical objects (also referred to as “items” hereinafter) on a screen or part thereof. The invention ensures that the graphical objects do not overlap even if a user places them in otherwise-overlapping positions, yet minimizes the use of limited screen resources and processing time. In particular, moving one or more of the existing graphical objects to the left is especially advantageous, since this oftentimes creates sufficient space without the need to move an existing graphical object to another line (hereinafter also referred to as “wrapping”), i.e. with a minimal amount of user interface actions and corresponding processing steps. At the same time, the available screen space is used as efficiently as possible, which is particularly advantageous in the context of devices with limited screen space, such as mobile phones or tablets.

The determination of the direction in which one or more of the graphical objects in the target line are moved can be made based on the current layout direction (left to right or right to left). Depending on different criteria, it may be desirable to preferably move objects in or against the current layout direction. By way of example and without limitation, operating systems provide applications with information on the current layout direction. The Microsoft Windows operating system provides this information under the LayoutDirection qualifier value:

### Windows.ApplicationModel.Resources.Core.ResourceManager.Current.DefaultContext.QualifierValues[“LayoutDirection”]

Google's Android mobile operating system provides a getLayoutDirection method for the object containing all device configuration information. Applications can acquire the current configuration by invoking the getConfiguration method of the object returned by the getResources( ) function and invoking getLayoutDirection( ) on the current configuration object.

In one aspect of the invention, the above-explained step of moving the at least one second graphical object further comprises moving at least a third one of the plurality of graphical objects to the right to create sufficient space for the first graphical object. Accordingly, such a bidirectional repositioning of existing graphical objects may create even larger space for the moved graphical object, while still avoiding wrapping actions in various situations, thereby also minimizing the amount of necessary user interface actions and corresponding processing steps.

The present invention also provides a computer-implemented method for processing drag-and-drop gestures on a user interface, which comprises in accordance with the embodiment of claim 3 the step of moving at least the left-most graphical object on the line to an overlying line to create sufficient space for the first graphical object. Such a left-bound wrapping creates even more space for the moved graphical object on the target line (since one or more existing graphical objects on that line are moved, i.e. wrapped, to the overlying line), while still causing as few user interface actions as possible, preferably if the above-described non-wrapping repositioning techniques still do not result in sufficient space for the moved graphical object.

In addition, the method may comprise the further step of moving at least the right-most graphical object on the line to an underlying line to create sufficient space for the first graphical object. Accordingly, such a bidirectional wrapping creates a maximum of available space for the moved graphical object.

The above described wrapping techniques, i.e. the moving of at least the left-most and/or right-most graphical object may be performed iteratively for the respective object on the overlying and/or underlying line. Such an iterative processing may be implemented by way of example and without limitation by means of recursive function calls, loops, or the like.

It will be appreciated that the present invention also encompasses embodiments in which all or only part of the above-explained repositioning techniques are combined (in particular the intra-line repositioning and the wrapping).

In another aspect of the present invention, any of the above-described methods may comprise the steps of simulating a plurality of alternative graphical object repositioning strategies prior to the repositioning of a graphical object and of determining a most efficient graphical object repositioning strategy. This way the impact (in terms of necessary user interface actions and corresponding processing steps) of possible candidate repositioning techniques can be evaluated beforehand, and the most efficient candidate can be selected for execution. The criteria for efficiency may include, by way of example and without limitation, a determination of whether a new line must be created, the number of rows affected by a repositioning, the total number of rows used, the number of graphical objects that must be wrapped from one line to another, the total distance of all needed graphical object repositionings, or any combination thereof.

Preferably, the user interface used in embodiments of the present invention is displayed on a touch-sensitive display of a portable electronic device. Accordingly, touch-sensitive screens are the preferred input device for the invention. This is also the input technology in connection with which the invention delivers the greatest relative benefit over known user interfaces. However, the invention is not tied to any particular input technology. Different input technologies enable alternative interfaces that serve similar purposes. For example, user interfaces relying on a mouse as well as a keyboard provide an efficient way to select multiple graphical objects by holding a key (commonly the Shift key) pressed while clicking on each object. The user can then move, assign or manipulate the entire set of selected objects at the same time, in a single operation, which may provide efficiency gains in certain contexts. Multiple-object selection is less efficient on a touchscreen. Therefore, certain alternative user interfaces relying on a mouse and a keyboard may enable users to perform certain operations, in general or in a specific context such as knowledge quantification, with a smaller number of input actions than with the preferred embodiment of the invention, especially if combined with keyboard shortcuts and/or context-sensitive menus. Such alternative user interfaces are, however, structurally different from the invention. All other things being equal, the invention consistently delivers all of its technical benefits.

The present invention is also directed to a computer program comprising instructions for implementing any of the above-described methods.

Furthermore, a portable electronic device is provided comprising a display, preferably a touch-sensitive display, configured for displaying a plurality of graphical objects on a user interface, at least two of said graphical objects each being associated with a data structure, at least two of said data structures being associated with a model answer of an automated knowledge quantification system, and a processor, configured for detecting a drag-and-drop gesture on the user interface indicating that a first one of the plurality of graphical objects is moved to a line comprising at least a second one of the plurality of graphical objects, for determining that the horizontal position of the first graphical object is in conflict with the at least one second graphical object, and for moving the at least one second graphical object to the left to create sufficient space for the first graphical object.

Lastly, the invention is directed to a portable electronic device, comprising a display, preferably a touch-sensitive display, configured for displaying a plurality of graphical objects on a user interface, at least two of said graphical objects each being associated with a data structure, at least two of said data structures being associated with a model answer of an automated knowledge quantification system, and a processor, configured for detecting a drag-and-drop gesture on the user interface indicating that a first one of the plurality of graphical objects is moved to a line comprising at least a second one of the plurality of graphical objects, for determining that the horizontal position of the first graphical object is in conflict with the at least one second graphical object, and for moving at least the left-most graphical object on the line to an overlying line to create sufficient space for the first graphical object.

Further advantageous modifications of the systems and methods according to embodiments of the present invention are defined in the appended claims.

### 5. BRIEF DESCRIPTION OF THE DRAWINGS

In the following detailed description, presently preferred embodiments of the invention are further described with reference to the following figures:

FIGS. 1-1 and 1-2: Exemplary screen layouts for grouping with labeled containers before and after user interaction in accordance with embodiments of the invention;

FIGS. 2-1 and 2-2: Exemplary screen layouts for grouping with unlabeled containers before and after user interaction in accordance with embodiments of the invention;

FIGS. 3-1 and 3-2: Exemplary screen layouts for one-dimensional sorting before and after user interaction in accordance with embodiments of the invention;

FIGS. 4-1 and 4-2: Exemplary screen layouts for two-dimensional sorting before and after user interaction in accordance with embodiments of the invention;

FIGS. 5-1 and 5-2: Exemplary screen layouts for combined grouping and sorting with containers before and after user interaction in accordance with embodiments of the invention;

FIG. 6: An exemplary line snap diagram in accordance with embodiments of the invention;

FIG. 7: An exemplary known grid snap diagram;

FIG. 8: An exemplary comparison of grouping input against correct grouping in accordance with embodiments of the invention;

FIG. 9: An exemplary differentiated scoring of grouping input in accordance with embodiments of the invention;

FIG. 10: An exemplary assignment of item to container in accordance with embodiments of the invention;

FIG. 11: An example of the six possible permutations of three groups in accordance with embodiments of the invention;

FIG. 12: A flowchart for generating permutations of item groups if user-formed number of groups matches correct number in accordance with embodiments of the invention;

FIG. 13: An exemplary comparison of sorting input against correct order with Kendall tau distance in accordance with embodiments of the invention;

FIG. 14: An exemplary comparison of sorting input against correct order with item-by-item distance in accordance with embodiments of the invention;

FIG. 15: An exemplary identification of user-determined one-dimensional (in this example, vertical) order of items (arbitrary item locations) in accordance with embodiments of the invention;

FIG. 16: An exemplary identification of user-determined two-dimensional order of items (arbitrary item locations; identifying rows) in accordance with embodiments of the invention;

FIG. 17: An exemplary visualization of identified user-determined two-dimensional order of items (arbitrary item locations; row lines) in accordance with embodiments of the invention;

FIG. 18: An exemplary snap grid cell with internal margins in accordance with embodiments of the invention;

FIG. 19: An exemplary snap line with external and internal margins and item-to-item spacing in accordance with embodiments of the invention;

FIG. 20: An example of identification of available space for insertion of new item in snap line in accordance with embodiments of the invention;

FIG. 21: A flowchart for determination of minimum and maximum X coordinates of item inserted in snap line without repositioning any other item (if item in target position, insert on right side) in accordance with embodiments of the invention;

FIG. 22: A flowchart for sum-based identification of available space for insertion of new item in snap line in accordance with embodiments of the invention;

FIGS. 23-1, 23-2, 23-3 and 23-4: Examples of item insertion (line snap) without wrapping in accordance with embodiments of the invention;

FIGS. 24-1, 24-2, 24-3, 24-4 and 24-5: Examples of right-bound wrapping (line snap) in accordance with embodiments of the invention;

FIG. 25: A flowchart for moving items to the right after inserting new item at left end of snap line (which was not empty) in accordance with embodiments of the invention;

FIG. 26: An example of calculating leftmost and rightmost options for items when moving items to the left (line snap) in accordance with embodiments of the invention;

FIG. 27: A flowchart for recursive wrapping of items (out at left margin of snap line, in at right margin) in accordance with embodiments of the invention;

FIG. 28: A flowchart for determining number of items to be wrapped out on left of snap line to gain given amount of space in accordance with embodiments of the invention;

FIG. 29: A flowchart for determining number of right wraps needed in addition to given number of left wraps (snap line) in accordance with embodiments of the invention;

FIGS. 30-1 and 30-2: Flowcharts for building wrap options (combinations of possible left wraps and right wraps; snap line) in accordance with embodiments of the invention;

FIG. 31: An exemplary screen layout for automatic space-saving snapping of items subsequently to their assignment to a container in accordance with embodiments of the invention; and

FIG. 32: An exemplary hardware layout in accordance with embodiments of the invention.

### 6. DETAILED DESCRIPTION

The present invention may be a device, a system, a method, one or more servers, including servers which are implemented as virtual machines, for brevity may be referred to herein as a server, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, a module refers to one or more routines, subsystems, and/or the like, whether implemented in hardware, software, firmware or some combination thereof. As would be understood by one of ordinary skill in the art, modules may be configured in many combinations to accomplish the same function. For instance, an example of a software module is any block of code that may be logically grouped together and may or may not use the conventional subroutine interfaces as defined by typical programming languages. A program routine or subroutine is generally understood as a stylistic convention of programming, and thus different routines or subroutines may be written in multiple combinations and accomplish the same function. As used herein, a “module” includes any block of code or programmable processor or chip having a function that may be logically grouped together regardless of whether conventional subroutine interfaces as defined by typical programming languages are used or specific processors or chip configurations are used.

### Overview

Preferred embodiments of the present invention receive, respond to, and evaluate gestures performed by one or more users with or on an input device 10, such as a touch-sensitive screen (cf. FIG. 32), in order to quantify the user's or users' knowledge of certain item relationships, the items being represented as graphical objects. The item relationships include the membership of an item in a particular item group (for example, the fact that a given mountain is located in a particular country), the order of a plurality of items by a given criterion (for example, the order of presidents by first term in office), and combinations thereof. While it would be possible to quantify the user's knowledge by means of a series of related questions (for example, requiring a user to enter or choose the country in which each of a series of given mountains is located, or requiring a user to choose the correct one of several alternative orders of presidents by first term in office), the invention enables users to modify, by means of repositioning graphical objects on a display, the assignment or ranking of any item (of a plurality of items) at any time prior to collective submission for evaluation of the entirety of choices made.

The invention optimizes, in response to user gestures, the simultaneous display of a plurality of items on a screen or part thereof. Embodiments of the invention ensure that items do not overlap even if a user places them in otherwise-overlapping positions, yet minimizes the use of limited screen resources and processing time by means of an optimizing snapping mechanism capable of identifying, within parameters dictated by usability and other design considerations, the most efficient strategy for repositioning items in order to prevent overlaps. The criteria for efficiency include, by way of example and without limitation, the number of rows affected by a repositioning, the total number of rows used, and the number of items that must be wrapped from one row to another row.

Embodiments of the invention depart from traditional wrapping mechanisms in that they analyze and, if found efficient, perform not only unidirectional but preferably also bidirectional wrapping operations, furthermore including the possibility of wrapping one or more items in one direction while simultaneously wrapping one or more other items in the opposite direction.

Embodiments of the invention are furthermore capable of determining a differentiated score for a set of choices submitted for evaluation, as will be explained in greater detail further below.

In the following, various user interface elements and repositioning techniques employed in embodiments of the invention will be described. It will be appreciated that the present invention concerns various embodiments comprising at least part or all of the below-described concepts.

### Waiting Spaces and Containers

### Labeled and Unlabeled Containers

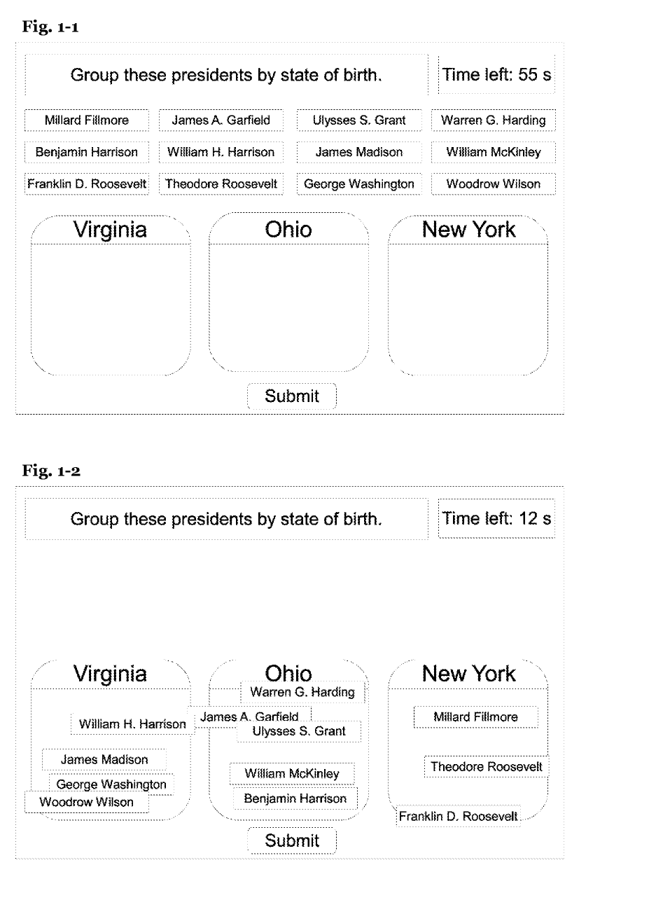

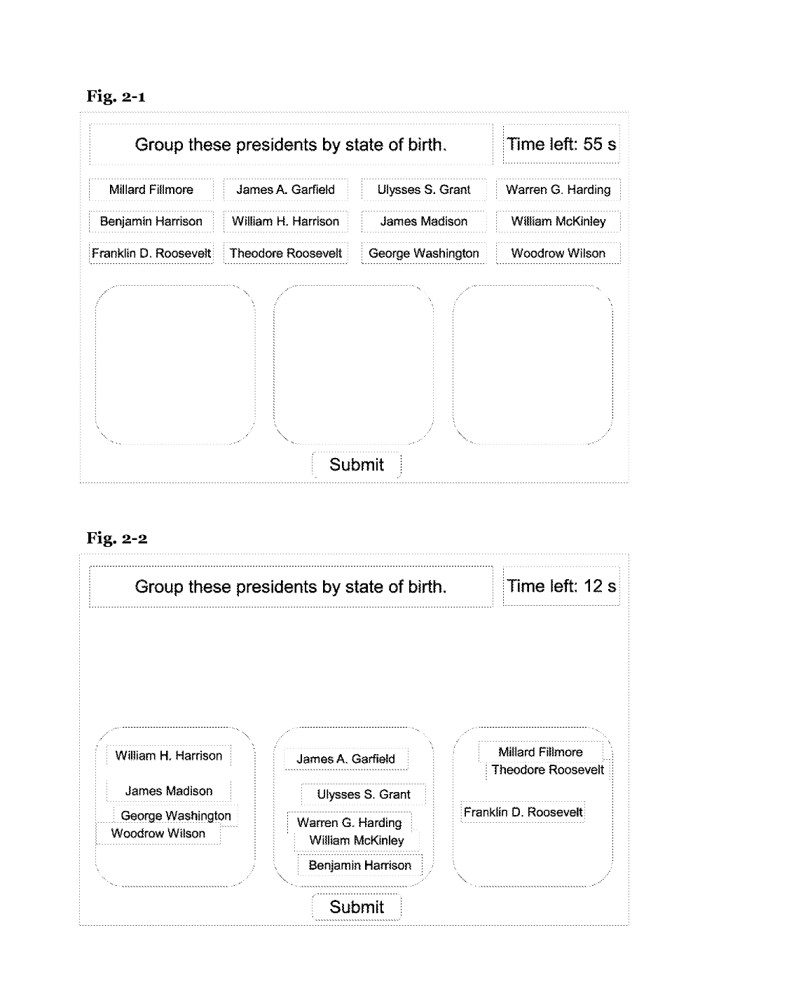

Embodiments of the invention which enable the user to group items involve the placement of movable graphical items in containers. FIG. 1-1 shows an exemplary screen layout before user interaction with three containers labeled as “Virginia”, “Ohio”, and “New York”. FIG. 1-2 shows a related exemplary screen layout after user interaction in a scenario in which the snapping aspect of the invention was not activated for the container areas. While containers have a uniform size in the depicted exemplary screen layouts, they may differ in size. They may, but need not, be placed next to each other.

Furthermore, containers need not be labeled. FIG. 2-1 shows an exemplary screen layout (before user interaction) with three unlabeled containers (see the rounded rectangles in the bottom half of FIG. 2-1). If containers are not labeled, a user may choose arbitrarily in which container to place the movable graphical objects representing items deemed to belong to a particular group. This degree of freedom requires the knowledge quantification system to analyze which correct group of items the content of a given container was presumably intended by the user to relate to.

### Waiting Space(s)

In FIGS. 1-1 and 2-1, all movable graphical objects are initially presented in a waiting space outside the containers, where they are waiting for each object to be placed in a container. It would also be possible to initially place all items in containers, as is the case in certain known techniques such as file managers. In a knowledge quantification system, the assignment of items to containers would be predefined or randomized. However, the existence of a distinct waiting space affords users the possibility to deliberately decline to assign an item to any particular container. In a knowledge quantification system, there may be a time limit for the assignment of items to containers, and any items unassigned after expiration of a timer would have to be evaluated explicitly (by processing the list of unassigned items) or implicitly (by ignoring unassigned items when evaluating the content of the containers).

In each of the above-mentioned exemplary screen layouts, there is a single, contiguous waiting space (above the containers). It would also be possible to provide a plurality of waiting spaces (for example, one waiting space above and one below the containers).

It is not a requirement that all items to be assigned to containers be initially displayed in the waiting space. Alternatively, a first number of items (possibly only one item at a time) could be displayed, and the next one would be displayed later (for example, after expiration of a timer or after the user has assigned or begun to assign a previously-displayed item to a container).

### Single-Container Setup

Preferred embodiments of the invention comprise a plurality of containers. However, the invention can also serve a practical purpose in a setup comprising one or more work spaces and a single container. In that case, the user would decide which items to assign to the one container. For example, in a knowledge quantification system the user may be asked to place the names of reptiles in a container, and the work space would contain animal names from a variety of groups besides reptiles, between which the user does not have to make a further distinction other than determining that they do not belong in the one container.

### Containerless Work Space(s)

In some embodiments of the invention, the only item relationship of interest is the order of a plurality of items, without a need to assign any item to any particular group. In that case, no containers are provided. Items would be ordered on a work space, which could also be divided up into multiple work spaces as opposed to constituting a single contiguous area. In technical terms, such a work space could be managed in ways entirely or substantially identical to the management of a waiting space.

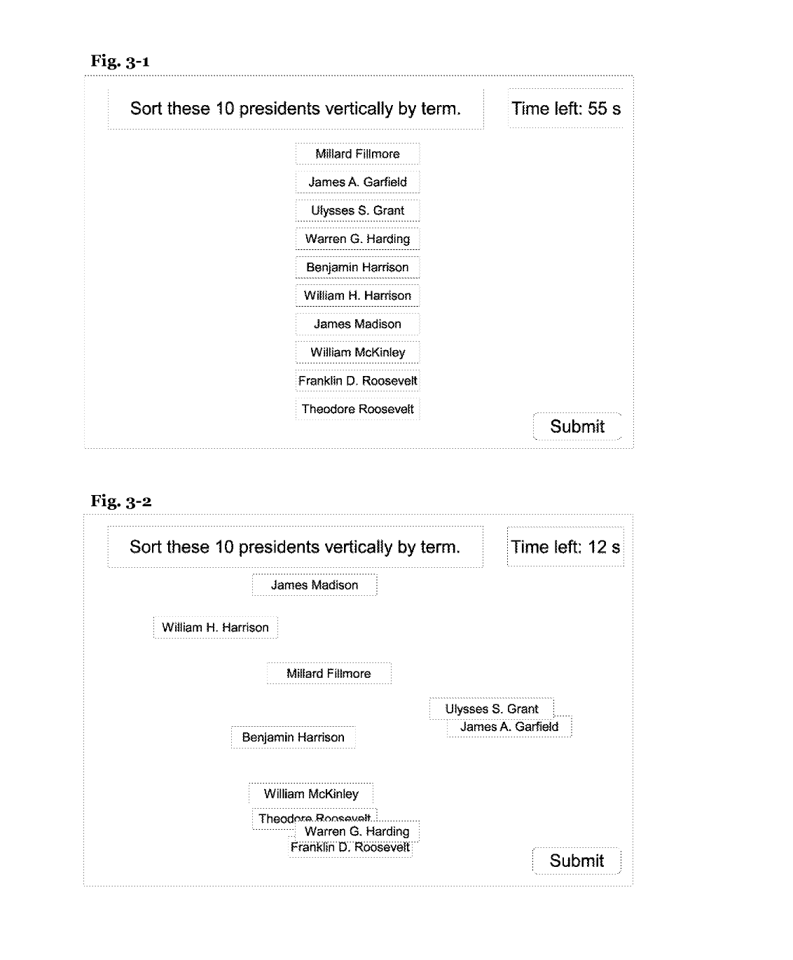

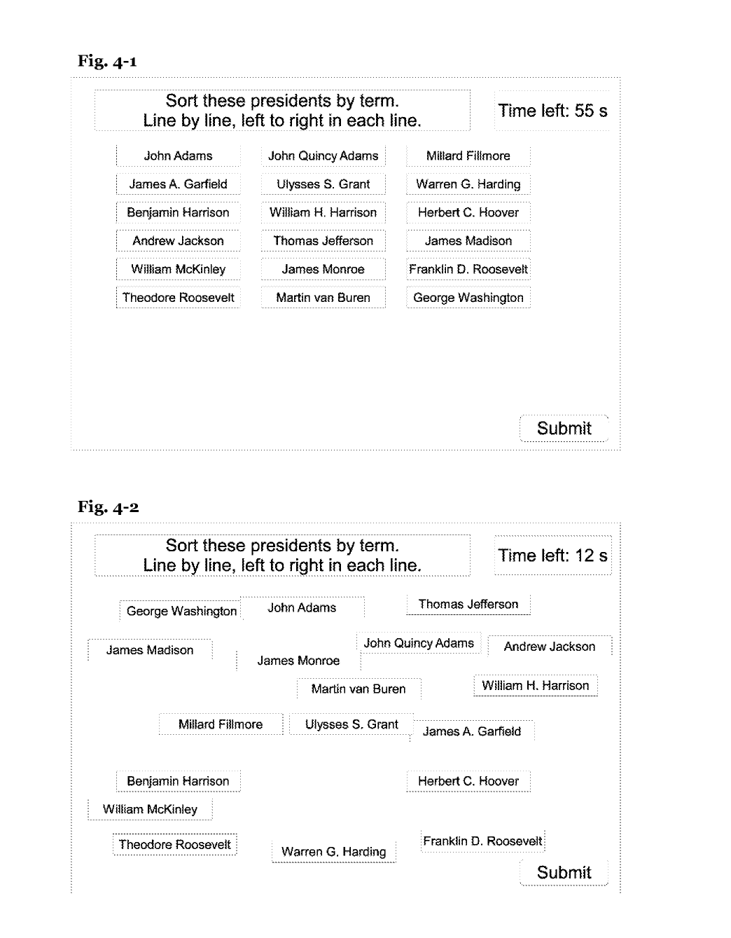

FIG. 3-1 shows an exemplary single work space for the one-dimensional (in this example, vertical) ordering of 10 items. FIG. 4-1 shows an exemplary single work space for the two-dimensional (in this example, left to right and top to bottom) ordering of 18 items.

It will be appreciated that certain embodiments of the invention also provide a combined grouping and ordering of items, as exemplarily illustrated in FIGS. 5-1 and 5-2.

### Snap Modes

### Grid Snap

Input technologies (such as, without limitation, touchscreens, touchpads, mice and keyboards) allow a user to drag a movable graphical object to an arbitrary location on a screen (at least within a designated screen region for drag-and-drop operations). However, the resolution of a display is typically much higher than the precision of manual movement of or on an input device. As a result, users will often place objects in positions where they overlap, or are overlapped by, other objects, and will likely, due to objective or self-imposed time constraints, arrange objects in ways that are perceived as scattered and may confuse users. The latter is particularly problematic if the objective is to indicate an order of a plurality of items, which order should be unambiguous to both the programmable electronic device and all users. Furthermore, if users manually attempt to avoid overlaps of items, they will likely (if they achieve this objective at all) leave more space between items than necessary, resulting in an inefficient use of screen space.

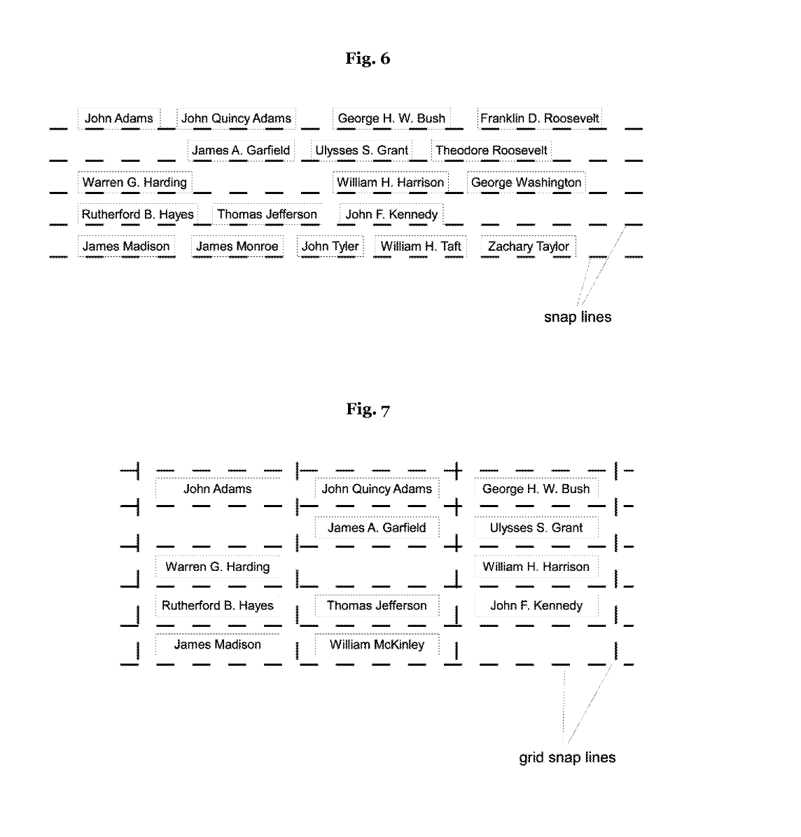

The snapping of items to (often, but not always, invisible) grids such as the example shown in FIG. 7 is known. Drawing programs generally offer a “Snap to Grid” feature. Icons representing files in a file manager can commonly be displayed in a grid format, as are the icons representing applications of mobile devices on start screens.

A two-dimensional grid generally comprises rows and columns. Each intersection of a row with a column is a grid cell. Grids can also be one-dimensional. For example, the drag-and-drop user interface of Google's Blogger website already described above is one-dimensional.

While it is not technically necessary for all cells to be of the same size, this is most commonly the case because each cell would in any event need to have the capacity to harbor the largest item that the user might place in it, making it an obvious choice to determine a uniform cell size (for example, the cell size dictated by the size of the largest item).

The assignment of a dropped item to a cell can be based on the size of the area of an overlap between an object being moved and a potential target cell, assigning the item to the cell with which it has the greatest overlap, or on a single point, such as the position of a mouse pointer, or on other criteria relating to the process of moving the object. This determination is potentially simplified if a grid is one-dimensional, in which case it may be possible to evaluate only one coordinate (X or Y).

An organized, uniform appearance of the movable graphical objects can be achieved by ensuring that the relative positioning of each movable graphical object within its grid cell is consistent. By way of example and without limitation, each movable graphical object can be vertically and horizontally centered within its cell (as shown in FIG. 7), or it could be aligned with any of the four corners of the cell.

It is not a technical requirement for the movable graphical objects to be of a uniform size. However, a uniform object size typically results in the most organized appearance, and no screen space would be gained by arranging variable-width items in a grid format.

If a movable graphical object is placed in a cell that already contains another object, the operation must either be blocked (which is technically possible, but not desirable) or result in a repositioning of one or more items in order to make room in the target cell (as described further below).

### Line Snap

While capable of delivering a highly-organized visual arrangement of items despite the lack of precision of manual movements of or on input devices, the grid snap technique has a shortcoming that is particularly significant in connection with small displays. And on displays of any size, it is inefficient if there is a significant discrepancy in the width required for different objects. For example, if a knowledge quantification system contains the names of certain European countries, the width required to display “France”, “Italy” or “Greece” is very significantly below that required to display “Czech Republic”, “Luxembourg” or “United Kingdom”, and only represents a fraction of the width required for a country that is officially a candidate for accession to the European Union under the name of “The former Yugoslav Republic of Macedonia” with no shorter correct alternative for the time being due to political controversy. A snap grid would have to provide room in each cell for the broadest item, although some, most or even all other items but one would fit in a cell of a fraction of that width, limiting the total number of items that can be displayed on a screen at the same time.

The line-snap aspect of embodiments of the present invention solves this problem by striking a balance between an organized, non-overlapping layout of items on the one hand and the objective of efficient use of screen space on the other hand. FIG. 6 shows an exemplary arrangement of items in snap lines (which, like grid lines, need not be invisible). Certain items such as “John Adams” (top line) and “John Tyler” (bottom line) are very small compared to certain other items such as “Franklin D. Roosevelt” (top line) and “Rutherford B. Hayes” (second line from the bottom). Therefore, the number of items that fit in a given snap line depends on the collective width, including spacings and margins, of the specific items placed in that line. For example, the top line in the example may have (depending on minimum spacings and margins) room for “John Tyler”, but not for “George Washington”.

Snap lines with variable-width items are in some, limited, ways akin to word processing documents. If room must be made in a given line for insertion of one or more items, a wrapping operation (moving one or more items from one line to another line), comparable in some respects to the wrapping of one or more words from one line to another in a text document, is required.

Whenever an item cannot be placed precisely in the target position determined by the user because it would result in overlaps with other items or insufficient spacings between items (i.e. generally speaking, if the item's target position is in conflict with other existing items), different options exist for determining the location of the inserted item and/or items being moved as a result of the insertion. For example, in certain embodiments of the invention the snapping technique may ensure that the items in a given line are aligned with the left margin, or that the spacings between a set of items, such as all items in a given line, are consistent.

While the present disclosure refers to snap “lines” with variable-“width” items because this would be the most common approach in the Western hemisphere, the invention could also be applied to snap “columns” with variable“height” items, which may be appropriate in some fields of use or some cultural contexts.

### Different Snap Modes for Different Screen Regions

Even if one or more waiting spaces and one or more containers are displayed simultaneously, it is possible to operate each screen region in a different snap mode in accordance with embodiments of the invention. For example, the exemplary screen layout shown in FIG. 1-2 does not show any snapping as far as the containers are concerned, but snapping could be activated for the waiting space above the containers.

Embodiments of the invention will often involve combinations of different snap modes. By way of example and without limitation, one particularly advantageous combination is that one or more waiting spaces have snap lines while one or more containers have a snap grid (for example, a one-dimensional, merely vertical, grid; in technical terms, a set of snap lines allowing only one item to be placed in each line is equivalent to a one-dimensional grid, both from the user's perspective and in terms of the internal operations to be performed). If a container is not broad enough to have room for more than one item per line (or if only a minority of lines could contain more than one item), it is often preferable to impose a limit by means of a one-dimensional snap grid.

Overflow from One Screen Region to Another

In certain scenarios such as, by way of example and without limitation, a setup comprising a waiting space and a container with a snap grid, the user may exceed the capacity limit of the snap grid of a container by inserting an additional item. While it would also be possible to block the operation, the preferred handling of this situation is an “overflow”: an item (typically the item at the bottom of the container) is pushed out of the container and into the waiting space (for example, and without limitation, next to the container). If the waiting space has some snapping technique (as the preferred embodiments of the invention do), it may then be necessary to make room by means of wrapping operations in the waiting space. In technical terms, an object dropped on the waiting space programmatically as a result of an overflow operation can be inserted (including any wrapping of other items that it may entail) in the same way as an item manually dropped on the waiting space by a user.

### Visualization of Snap Grids and Snap Lines

Snap grids and snap lines can be, and in many embodiments are, invisible. However, a person skilled in the art knows different ways to visually represent snap lines and cells. For example, snap lines could be underlined, and snap grids could be displayed as grids consisting of vertical and horizontal lines (comparable to a table). Alternatively, the background of each snap line (or each row in a two-dimensional grid) could be colored. For example, one line may have a dark background, while the next line has a light background (or simply the background color of the environment). Such visualizations could also occur only if the user moves an object over a given line. As opposed to displaying entire grids or lines, a context-sensitive display could also be limited to a target grid cell or to a particular insertion space on a snap line.

Automatic Space-Saving Shrinking of Items Subsequently to their Assignment to a Container

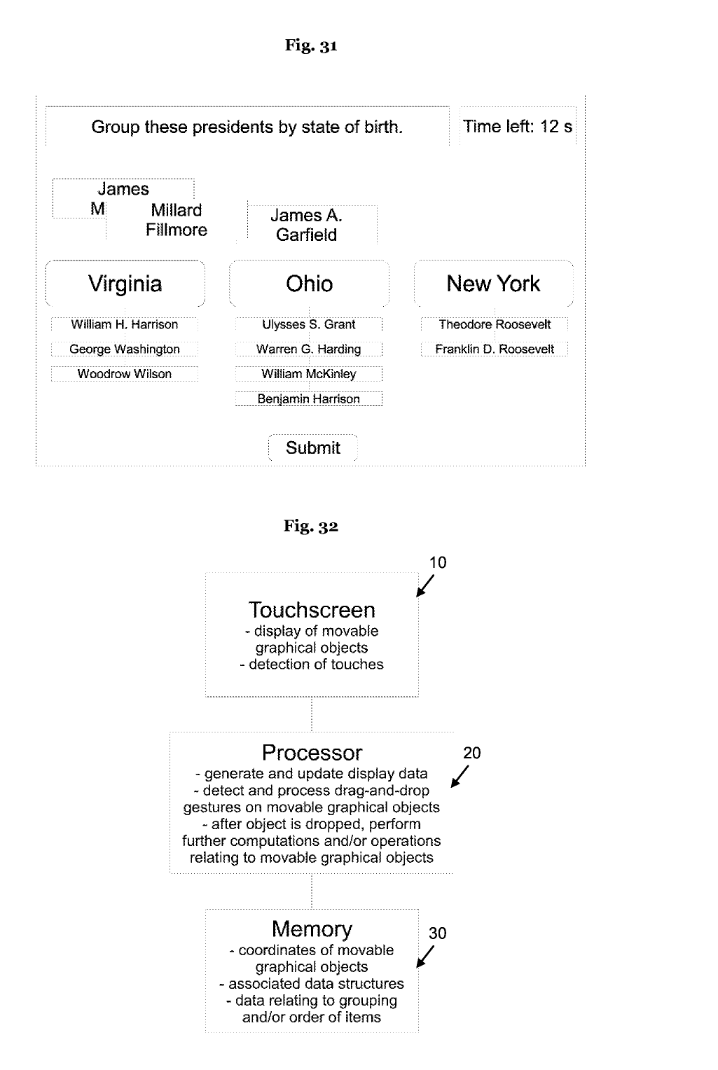

While the size of each movable graphical object remains unchanged in most embodiments of the invention, some other embodiments may save screen space by shrinking items during or after their assignment to a container. FIG. 31 shows an exemplary screen layout in which the movable graphical objects in the waiting space (such as “James A. Garfield”) are larger than the movable graphical items placed in the three containers (“Virginia”, “Ohio”, “New York”). That exemplary screen layout additionally does not display a frame around the objects in the container but connects objects with vertical lines.

The shrinking of items can be implemented as follows. There are either two different graphical objects (a larger one and a smaller one) relating to the same item, or there are two layouts and the properties of the graphical objects are changed on the fly. The larger object, or the larger layout of an object, is displayed and can be moved around in the waiting space. Once the larger object or larger layout enters a container area or is dropped while touching the container area, it is replaced with the smaller object or the layout of the one object is replaced with the smaller layout. The item is then integrated into the container by means of snapping. If the user decides to move the smaller item or smaller layout again, the original size may be activated in response to picking up the item, in response to a movement across a certain distance, in response to leaving or entering a particular screen region, or in response to expiration of a timer.

### Item Placement and Wrapping

### Placement of Item in Empty Grid Cell

As explained further above, items to be placed in grid cells need not be of a uniform size, but in any event each cell must have capacity for even the largest item. As also explained further above, there are different options for the positioning of an item within a grid cell because an organized screen layout is achieved as long as the relative position of each item within its grid cell is consistent.

FIG. 18 shows an exemplary structure of a grid cell with internal margins (which are not a requirement) and an item space between those margins. If each item had the size of the item space, its top left corner would be aligned with the top left corner of the item space of the cell; otherwise, the item would be centered within the item space or be placed consistently in a particular corner of the item space or have a consistent distance from a particular side or corner of the item space.

Grid cells can also have fewer than four internal margins. By way of example and without limitation, there could be only a vertical margin, or two horizontal margins without a vertical margin.

### Placement of Item in Sufficiently Broad Gap in Snap Line

Like grid cells, snap lines can (but need not) have internal margins, and if they have internal margins at all, the number of margins can range from 1 to 4. In order to avoid item overlaps, snap lines must maintain a minimum horizontal item-to-item distance.

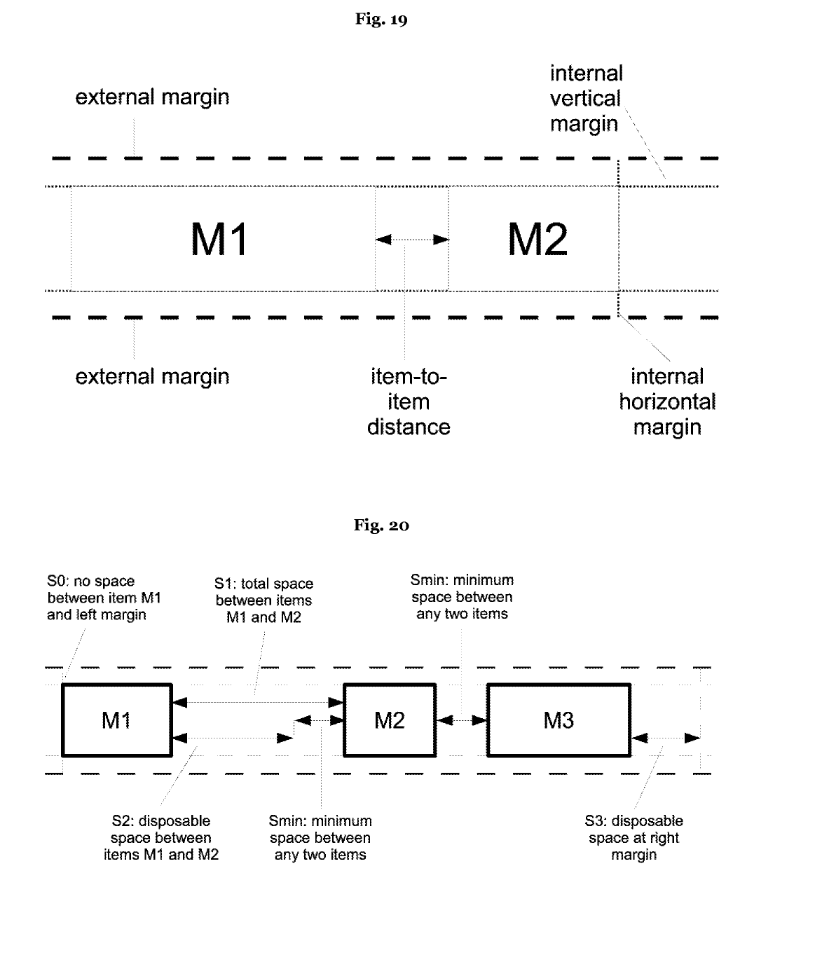

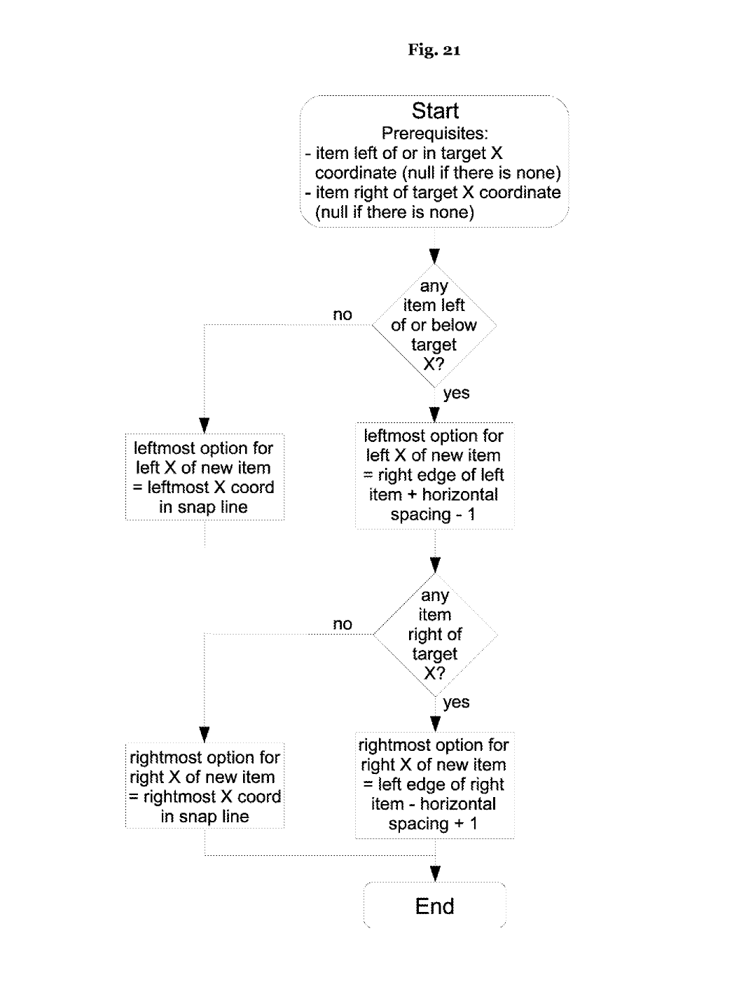

FIG. 19 shows an exemplary snap line structure with not only external but also internal vertical margins. There are two internal vertical margins in the example and an internal horizontal margin at the right side. Items M1 and M2 have an item-to-item distance that is greater than or equal to the minimum horizontal item-to-item distance required. Therefore, if M2 were not already in that row (as it is in FIG. 19) but were dropped in that position, it could be inserted without a need to reposition any other items. The X coordinate of the target position would have to be, at a minimum, the right X coordinate of M1 plus the minimum item-to-distance minus 1. FIG. 21 is an exemplary flowchart for the determination of minimum and maximum X coordinates of an item inserted in a snap line without having to reposition any other item or after having made room by performing repositionings as needed. The assumption is that if there is an item in the target position, the new item should be inserted to the right of the item already in the target position. The leftmost option for the left X coordinate of the new item is calculated in accordance with the previously-explained formula. In the event that there already is an item to the right of the item to be inserted, the post-insertion right X coordinate of the new item must not be greater than the left X coordinate of the item on the right minus the minimum horizontal item-to-item spacing plus 1.

### Identification of Available Space for Insertion of New Item in Snap Line

If an item is inserted in a snap line, the first determination to be performed is whether there is sufficient space for the item in the target position, i.e., in the place where the user has dropped it. If there is no item in the target line, then there must be enough space (no item can be larger than the target line). Target lines are typically of a uniform width, although target lines could also differ in width, provided that even the narrowest target line has sufficient room for the largest item.

If there are one or more items in the target line but the place where the user has dropped the item being moved does not result in an overlap of the item being moved with any of the items already in the line, or with the minimum space required between items, then the item can be inserted in the particular position in which the user has dropped it.

If the item should be inserted between two items (by way of example and without limitation, the criterion could be that the point at which the user has touched the item when picking it up is right of the horizontal middle of a first item already in the line), but there would be an overlap or less than the minimum required horizontal space between items if it was placed precisely where dropped, the X coordinate of the target position would have to be the right X coordinate of the left ones of the two items plus the minimum item-to-item distance plus 1. This also applies to the insertion of an item between the left margin of a line and the first (leftmost) item. In case an item is meant to be inserted between the last (rightmost) item in the line and the right margin, then there is sufficient space for direct insertion (i.e., without repositioning of other items) if the X coordinate of the right margin of the line minus the width of the item to be inserted minus the minimum item-to-item spacing is greater than the right coordinate of the right-most item already in the line.

FIG. 20 shows an exemplary snap line with three items (M1, M2 and M3) and the identification of disposable space between items. There is no space (S0) between item M1 and the left margin. Between M1 and M2, there is a total space of S1. The disposable space between M1 and M2 (space that could be made available for the insertion of new items including the insertion of additional item-to-item spacings) is S2 (S1 minus the minimum item-to-item distance, Smin). Between M2 and M3, there is only the minimum spacing between two items (Smin) and, therefore, no disposable space. All of the space S3 between item M3 and the right margin is disposable: the rightmost item in a given line does not need an item-to-item spacing to its right. In total, S2 and S3 could be made available for the insertion of new items and their spacings. The aggregate of S2 and S3 could be made available in a single position by repositioning some items within the line (i.e., without a need to wrap them into other lines if the total space required does not exceed S2+S3).

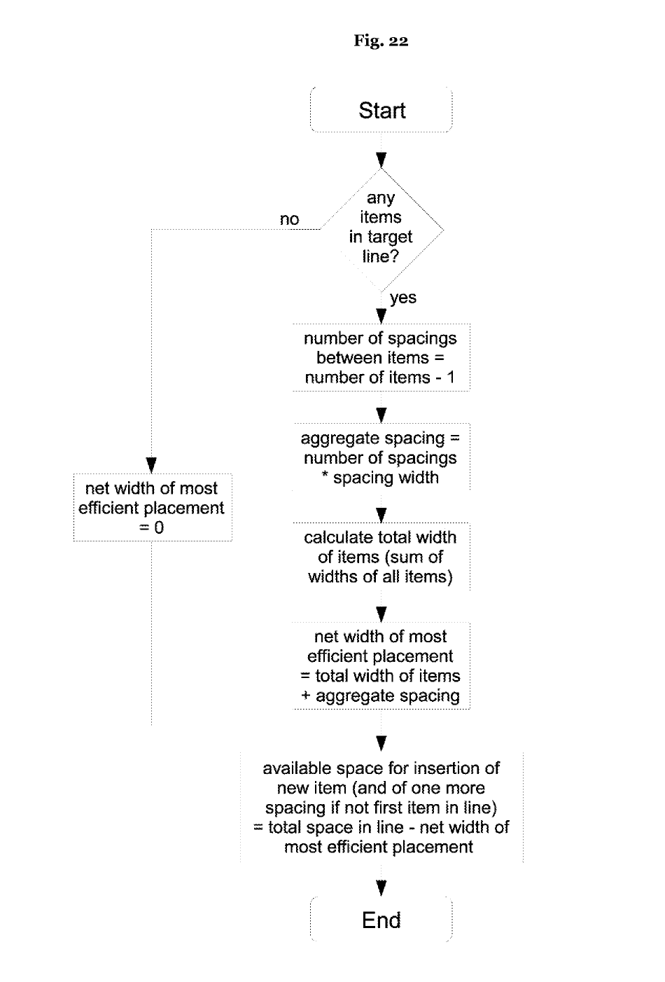

The aggregate disposable space in a given snap line could be identified by evaluating each item-to-item or margin-to-item distance and building the sum of all disposable spacings. However, this determination can be reached more efficiently by identifying the available space for insertion of a new item on the basis of sums as shown in FIG. 22. In that exemplary flowchart, the first part is the determination of the net width of the most efficient placement of all items (i.e., between any two neighbor items there is precisely the minimum horizontal item-to-item spacing). If there are no items in the target snap line, then the net width of the most efficient placement is o. Otherwise, the number of spacings is 1 less than the number of items; the aggregate spacing is the number of spacings multiplied by the width of the minimum spacing, which must be added to the total width of all items (which can be calculated with a simple loop). After determining the net width of the most efficient placement of items in the line, the space available for insertion of a new item (and for insertion of one more minimum horizontal item-to-item spacing unless the inserted item will be the first item in the line) is the total space available in the line (total net width) minus the net width of the most efficient placement.

Placement of Item in Snap Line with Sufficient Aggregate Space but Insufficient Space in Target Position

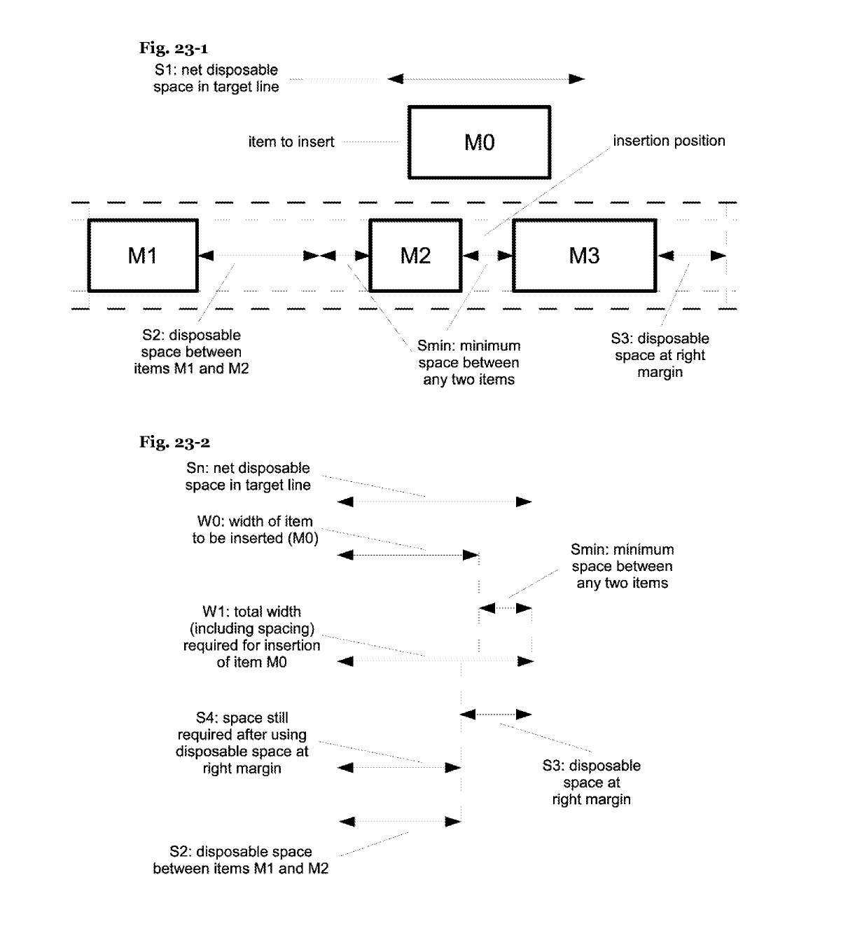

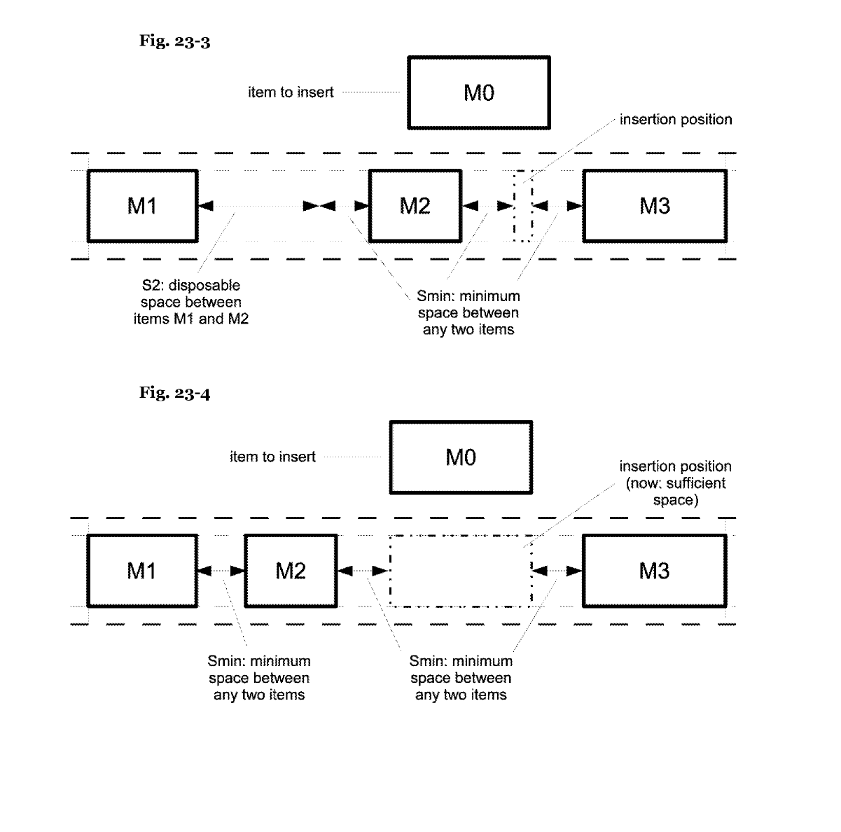

While embodiments of the invention are capable of wrapping items from one line to another line (including simultaneous bidirectional wrapping), it is recommended for both performance and usability reasons to avoid wrapping operations if an item can be inserted into a snap line by making room for the item only within the target line. FIG. 23-1 shows an exemplary situation in which this is possible and advisable. Even though item M0 does not fit (in view of the requirements for a minimum space Smin between any two items) in between items M1 and M2, much less between M2 and M3 or between M3 and the right margin (and there is no space at all between the left margin and M1), the total net disposable space in the target line would be sufficient for item M0 and an additional minimum space Smin. However, the net disposable space S1 is composed of the disposable space between M1 and M2 (S2), which is the space between those items minus one spacing, and the disposable space between M3 and the right margin of the line.

FIG. 23-2 compares the disposable and required quantities of horizontal space. The net disposable space available in the target line Sn (corresponding to S1 in FIG. 23-1) equals W1, which is the sum of W0 (the width of the item to be inserted, i.e., item M0) and one minimum space Smin. W1 is also the sum of the disposable space S3 at the right margin and the disposable S2 between items M1 and M2.

FIG. 23-3 shows an exemplary first step in which space is made on the right by moving M3 to the right so as to align it with the right margin and to free up the space previously available between M3 and the right margin. It would also be possible to start on the other (left) side.

Moving item M3 to the right end increases the space between M2 and M3 from one minimum spacing Smin to twice Smin (since another minimum distance is needed once item M0 is inserted in between M2 and M3) and a small quantity of additional space between the two minimum spacings. Disposable space S2 to the left of M2 remains unchanged at this point but is freed up in the next step.

FIG. 23-4 shows an exemplary second step in which item M2 is moved to the leftmost position, i.e., it is pushed so far to the left that the space between M1 and M2 is reduced to the minimum space Smin. As a result, the space between M2 and M3 increases to the extent that item M0 can now be inserted.

In the aggregate, FIGS. 23-1, 23-2, 23-3 and 23-4 demonstrate a bidirectional repositioning of items within the same snap line. In some situations, it will be sufficient to reposition items unidirectionally, while in other directions the ability to make room by means of bidirectional repositioning will obviate the need to wrap one or more items into one or more other lines. Avoiding line wraps is not only desirable from a usability point of view because users will find it easier to follow position changes in a single target line (which can be animated so as to show the one or more repositionings needed to free up the required space) but also makes more efficient use of computing resources (even more so, but not only, if the repositionings are shown in the form of animations), given that it is more efficient for a programmable electronic device to perform computations based on the coordinates of items than to move objects consisting of hundreds, more likely thousands of pixels each.

### Right-Bound Wrapping of Items

If the insertion of an item (and an additional minimum item-to-item spacing) into a snap line requires more space than the aggregate amount of disposable space in that line, repositioning items within the line is not sufficient and one or more items must be wrapped over to other lines. Unlike conventional wrapping techniques, embodiments of the invention are capable of wrapping items bidirectionally and of determining an optimal (in terms of the use of screen space and other computing resources) wrapping strategy.

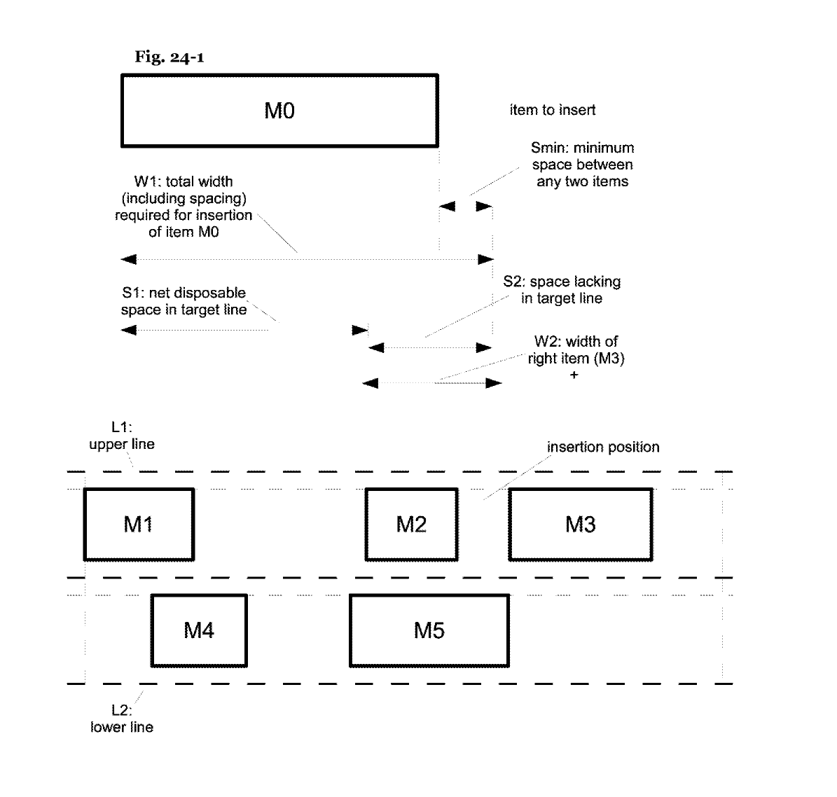

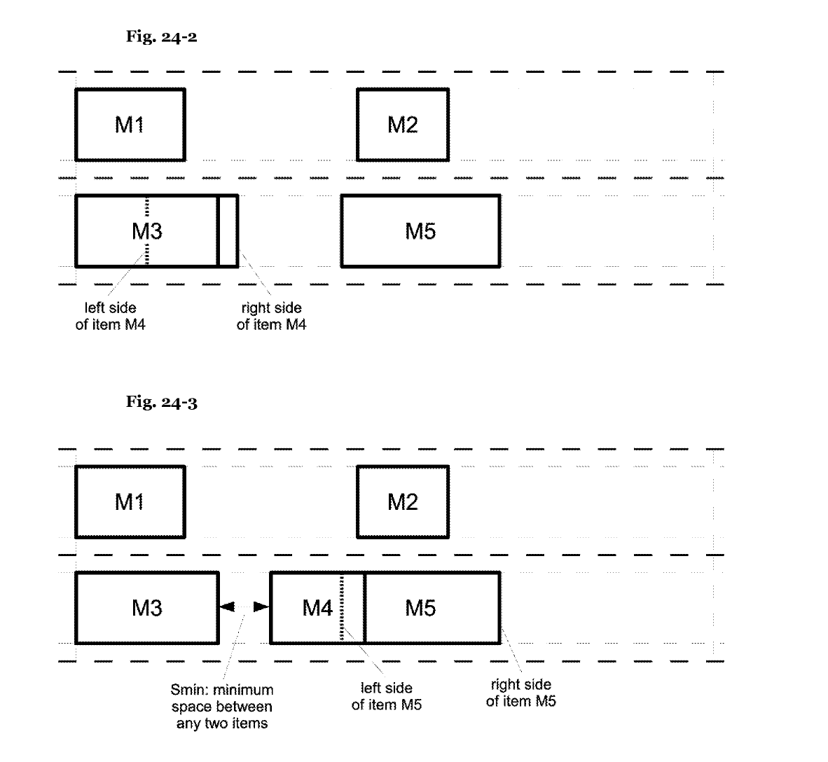

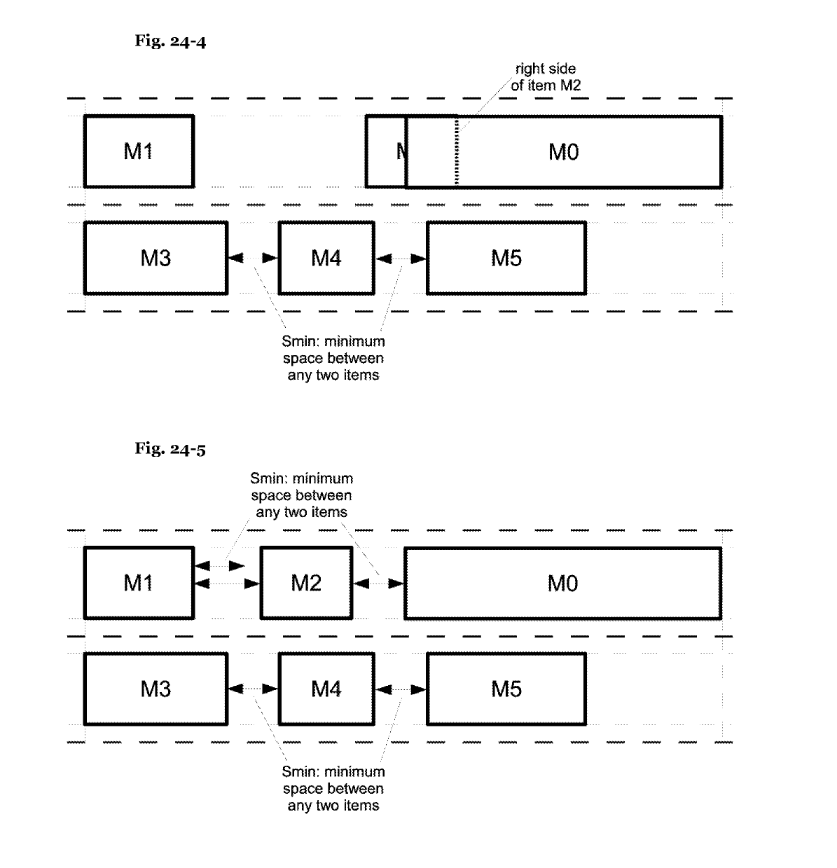

FIG. 24-1 shows an exemplary original situation in which the total width W1 of the item to be inserted (M0) and the additionally-required minimum space Smin exceeds the net disposable space S1 in the target line by the amount of lacking space S2, but the width W2 of the rightmost item M3 exceeds the lacking space S2 on its own (and to an even greater extent if item M3 is wrapped into another line, thereby rendering one minimum space Smin unnecessary in the target line L1 for the insertion operation). Therefore, wrapping W2 into another line is sufficient to free up the required space. Since M3 is at the right end of the line, the direction in which to wrap this time is to the right, i.e., to the line below (L2), where there are already items M4 and M5.

FIG. 24-2 shows the effect of wrapping item M3 from the upper line L1 into the lower line L2 and of positioning it at the left end of L2, where it overlaps a large part of item M4. The invention avoids overlaps. Overlaps may occur temporarily in the internal data structures, but must be remedies. Overlaps may also occur temporarily in certain embodiments of the invention that indicate the repositioning of items by means of animated graphics, with minimum spaces between items ensured and overlaps prevented at the end of an animation.

FIG. 24-3 shows a possible first step of resolving the overlap between items M3 and M4 by moving M4 to the right so as to ensure a minimum space Smin between M3 and M4. However, this repositioning results in an overlap between items M4 and M5.

In FIG. 24-4, item M5 is moved to the right so as to ensure a minimum space Smin between M4 and M5. Item M5 does not overlap any other item because there is no item right of M5 in line L2. For the purposes of this example, line L2 is complete. Furthermore, FIG. 24-4 also shows that item M0 is inserted at the right end of line L1, where it overlaps part of item M2.

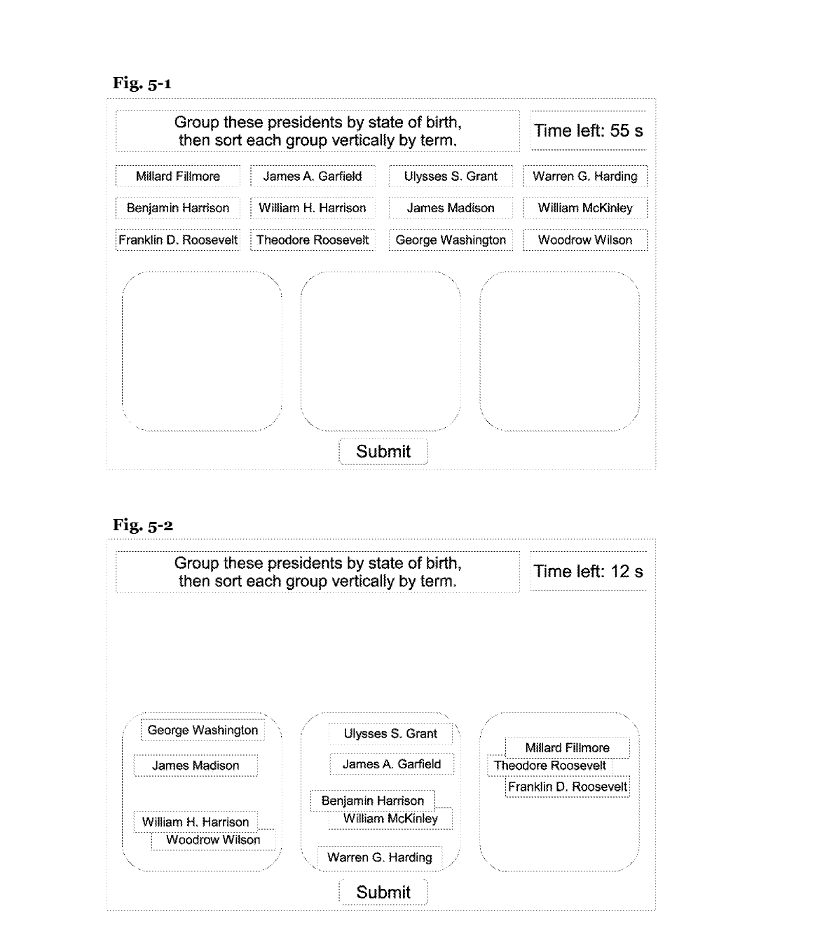

FIG. 24-5 shows the final step relating to line L1: item M2 is moved to the left so as to ensure a minimum space Smin between items M2 and M0. The spacing between items M1 and M2 is reduced, but it still exceeds the minimum space Smin.

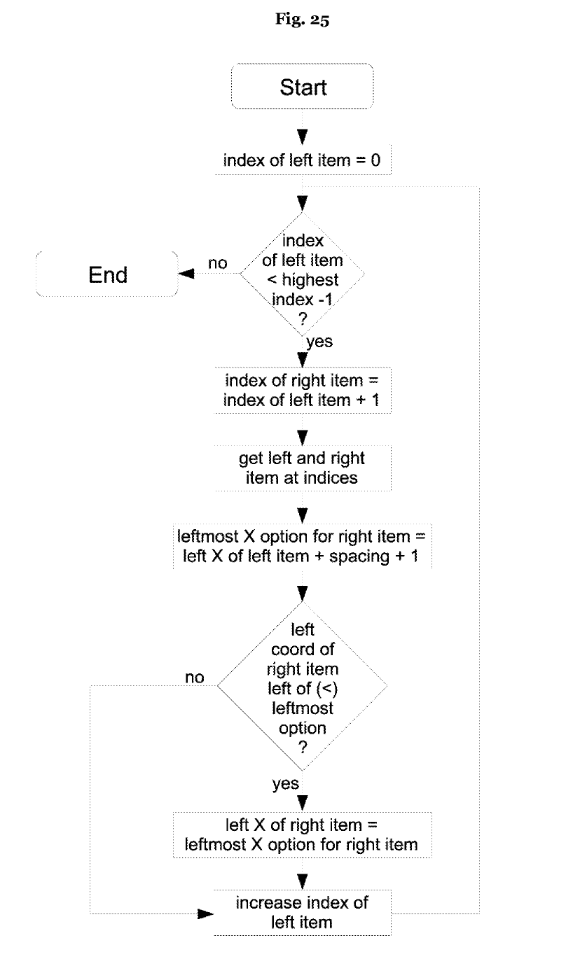

FIG. 25 is an exemplary flowchart for moving items to the right after inserting a new item at the left end of a non-empty snap line, such as the repositionings shown in FIGS. 24-3 and 24-4 in the lower line L2. The loop for moving items to the right starts at 0, the index of the (new) leftmost item. If items are moved to the right within a line after insertion of a new item in a different position, the start index may be higher than in this exemplary flowchart. The loop processes all indices from the start index up to the second-highest index as the index of the left item of each loop run, and the index of the right item of each loop run is the left index plus 1. The loop determines the leftmost (lowest) X coordinate possible for the right item without a resulting overlap between the left item and the right item. That coordinate is the leftmost coordinate of the left item plus the minimum spacing required plus 1. If the left coordinate of the left item is left of (i.e., lower than) the just-determined leftmost option, it is adjusted accordingly. Otherwise no coordinate must be changed during this loop run. Depending on the details of a particular embodiment, identification of the first pair of items requiring no coordinate adjustment may be an opportunity to exit the entire loop.

Any wrapping operation can trigger a chain reaction: items wrapped out of a first line and into a second line may require items to be wrapped out of the second line into a third line, and so forth. Multi-line wrapping will be explained further below.

### Left-Bound Wrapping of Items

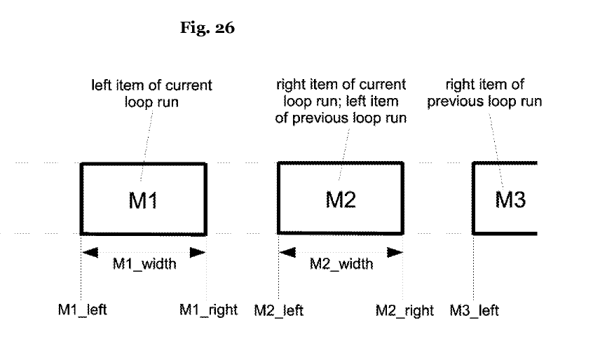

If an item is wrapped out at the left end of a line and placed at the right end of the line above, some or all of the items previously in the upper line may have to be moved to the left so as to avoid overlaps and ensure a minimum item-to-item space. The related loop has to start at the right. It can process items pair by pair as in the example or it can store the X coordinate of each previous item (starting with the X coordinate of the right margin of the snap line) in a variable for the subsequent loop run. FIG. 26 shows an exemplary set of three items (M1, M2, M3) in a line, whereby the pair of the current loop run consists of M1 (left item of current loop run) and M2 (right item of current loop run) and the pair of the previous loop run consisted of M2 (left item of previous loop run) and M3 (right item of previous loop run). The rightmost (highest) permissible left X coordinate of item M2 so as to ensure a minimum space between M2 and M3 can be determined by firstly calculating the rightmost (highest) permissible right X coordinate of M2, which is the left coordinate of M3 (M3 left) or, if the rightmost item is processed, the X coordinate of the right margin of the snap line, minus the width of the right item (M3) plus 1. By subtracting the width of a minimum item-to-item spacing and the number 1 from that rightmost (highest) permissible left X coordinate of item M2, the rightmost (highest) permissible left X coordinate of item M2 is identified. If necessary, that left coordinate must be adjusted.

### Iterative Multi-Line Wrapping

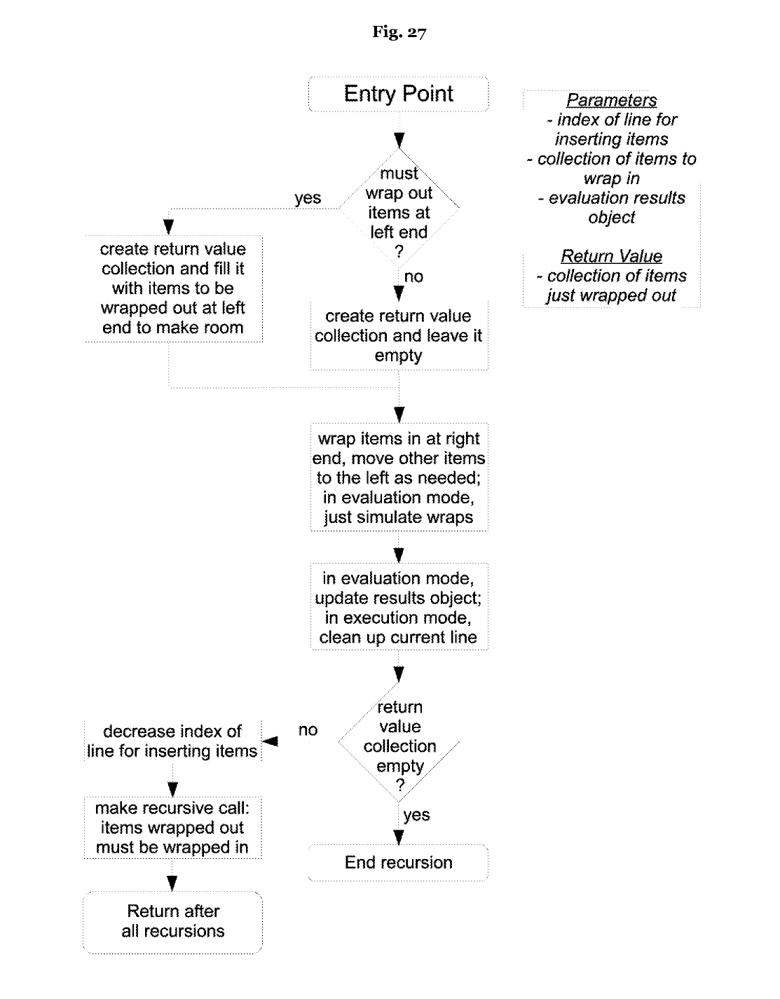

As mentioned further above, items wrapped out of a first line and into a second line may require items to be wrapped out of the second line into a third line, and so forth. FIG. 27 is an exemplary flowchart for the recursive wrapping of one or more items out at the left end of each snap line and into the line above, where the one or more items are inserted at the right end. The recursive function receives three parameters: the index of the line in which to insert the one or more items, a collection containing the one or more items to wrap into the new line, and (with a view to the determination of an optimal wrapping strategy as discussed further below) an evaluation results object in which the technical impact of a wrapping operation is stored if the function is called in evaluation mode (whether the operation takes place in evaluation mode could be communicated via an additional parameter, through a data field in an object, or by passing a null value for the evaluation results object in non-evaluation mode). The return value of the recursive function is a collection of the items wrapped out of the line last processed. Recursion will end once the return value collection is empty, i.e., once an insertion has been made into a line where there was enough space so as not to require further wrapping. If the return value collection is not empty but there are no more lines to process, and if there is furthermore a technical restriction (because of the design goal to keep all movable objects visible at the same time without scrolling or other space-extending operations) not to create additional lines, the operation cannot be performed, a fact that should preferably be identified in evaluation mode (in which case a value would be communicated, typically by setting a flag in the evaluation results object, that indicates the infeasibility of the operation evaluated).

A person skilled in the art knows how to apply the same recursive structure to a right-bound wrapping operation, in which items are wrapped out at the right end (instead of the left end), wrapped in at the left end (instead of the right end), and the line index increases. A person skilled in the art furthermore knows how to perform multi-line wrapping by means of other iterative program structures than a literally-recursive structure, such as (by way of example and without limitation) a loop with or without a stack.

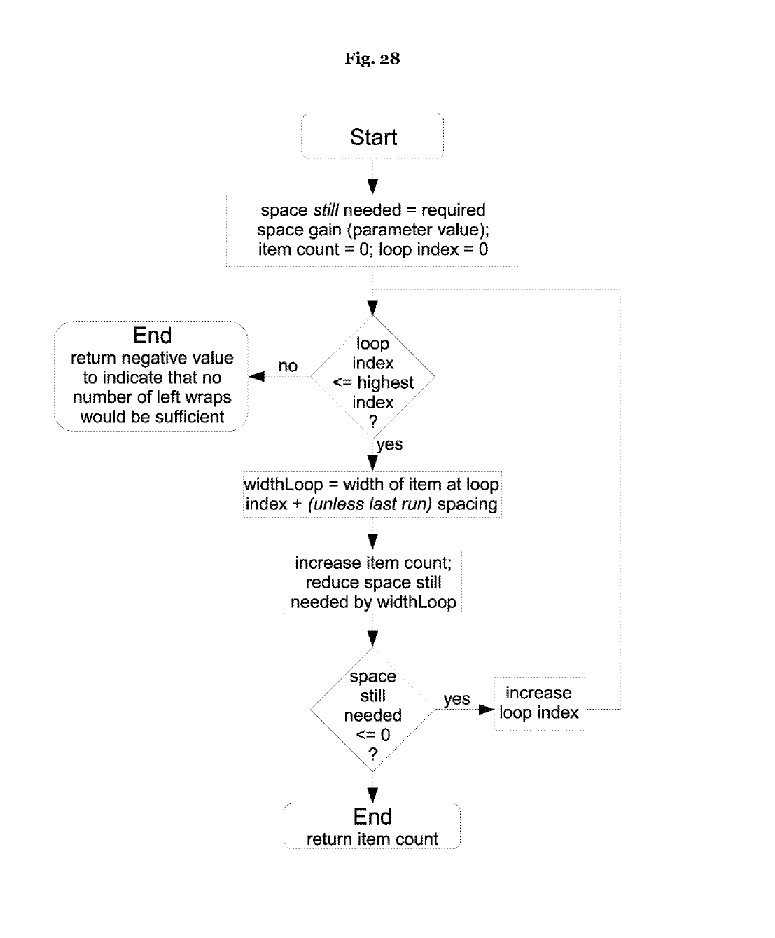

The determination of whether items must be wrapped out of a line (and if so, how many) is shown by the exemplary flowchart in FIG. 28. The initialization occurring before that exemplary loop sets a variable for the space still needed to the required space gain, which is usually the difference between the disposable space in a given line and the space required for insertion of one or more items and the related item-to-item spacing(s). The initialization part also sets the item count and the loop index to zero. The loop index cannot exceed the highest index. If the highest index would be exceeded, a negative value is returned to the calling code so as to indicate that no number of left wraps would be sufficient to free up the required space; otherwise the loop would have been terminated before by returning an item count after finding that the amount of space still needed has reached or gone below zero.

A person skilled in the art knows how to apply the same logic to a determination of the number of items to be wrapped out on the right end of a snap line by means of a loop starting at the opposite end and working its way in the opposite direction (decreasing item index).

### Determination of Optimal Bidirectional Wrapping Strategy

It is a key aspect of embodiments of the invention that, unlike a conventional unidirectional wrapping technique that has no choice of direction, it is capable of choosing an optimal wrapping strategy. It has been discussed further above that embodiments of the invention are capable of avoiding wrapping operations entirely by repositioning items within a line, which can also be a bidirectional operation (moving items left and right of the insertion position so as to make room for a new item). A more efficient use of screen space and of other computing resources (such as processing time) is made by minimizing the number of lines that contain items, by minimizing the number of lines affected by a wrapping operation, and by minimizing the number of items to be wrapped from one line to another. The efficiency gain is even greater in scenarios in which the repositioning of items is visualized by means of animated graphics.

Program code can be written that is capable of operating in two modes, an evaluation-only mode (in which the technical impact of a wrapping operation is stored in an evaluation results object but no actual repositionings occur) and an actual-repositioning mode. Alternatively, different sets of program code can be written. This choice of structure is merely a question of code design without further technical implications. The relevant technical aspect is the ability of the invention to perform an impact assessment of alternative wrapping strategies prior to actually repositioning items.

When identifying the need to wrap one or more items out of a target line, the invention can evaluate some or all of the wrapping options available to it: by wrapping unidirectionally on the right end (if the insertion position is right of the rightmost item in the target line, the item to be inserted would be the item to be wrapped), by wrapping unidirectionally on the left end (if the insertion position is left of the leftmost item in the target, the item to be inserted would be the item to be wrapped), or by one or more combinations of A number of left wraps and B number of right wraps.

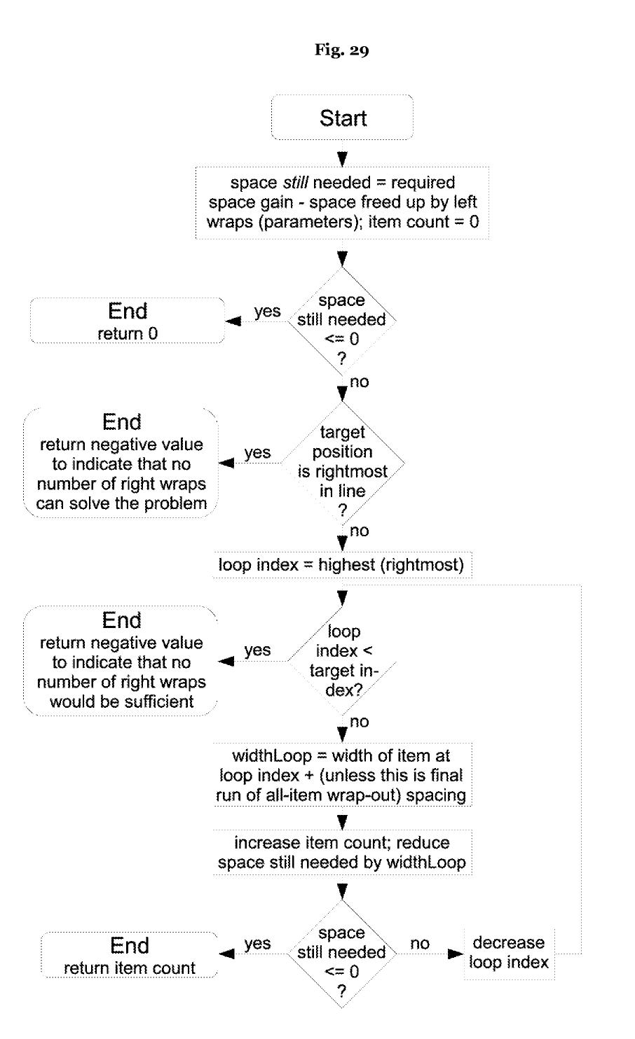

It has been explained further above how to determine the number of items to be wrapped out on one end of a snap line so as to free up a required quantity of space (FIG. 28). FIG. 29 is an exemplary flowchart for determining the number of right wraps needed in addition to a given number of left wraps. The parameters for that sample function include the required space gain as well as the space already freed up on the left side. Prior to the loop, the item count is initialized by setting it to zero, and an item count of zero is returned if the space freed up by left wraps is sufficient all by itself. If there is a need to free up more space on the right side but the target position (another parameter of the function) is already the rightmost position in the line, then there is no number of right wraps capable of complementing a given number of left wraps in order to free up the required space.

If the loop index exceeds the target index for the insertion but the loop has not been aborted before, it is clear that no number of right wraps would be sufficient, which must be reported back to the calling code (in the example, and without limitation, by means of returning a negative value).

Each loop run determines the widthLoop value, which is the width of the item at the loop index (i.e., the next item that can be wrapped out) as well as a minimum item-to-item spacing unless this is the final run of a wrapping operation involving all items. The item count is increased during each loop run while the space still needed is reduced by widthLoop. If the space still needed hits or goes below zero, the required number of items has been identified and the item count is returned; otherwise the item index is decreased (so as to advance further left) and the loop continues with that new index.

A person skilled in the art knows how to apply the same approach to the determination of the number of left wraps needed in addition to a given number of right wraps.

This determination of a complementary number of wraps is a prerequisite for building a collection of all wrap options. Each wrap option indicates how many items to wrap out on the left side (if any) and how many on the right side (if any). Zero items on both sides at the same time would not be a valid option. At least one of the two values must be greater than zero, and it is possible for both to be greater than zero, in which latter case a simultaneous bidirectional wrapping operation will occur. In technical terms, a bidirectional wrapping operation will be sequential, and there is freedom of choice with respect to the visualization of the repositioning of items. However, it is simultaneous in the sense that a single user action (dropping an item in a target position for insertion) triggers both one or more left wraps and one or more right wraps.

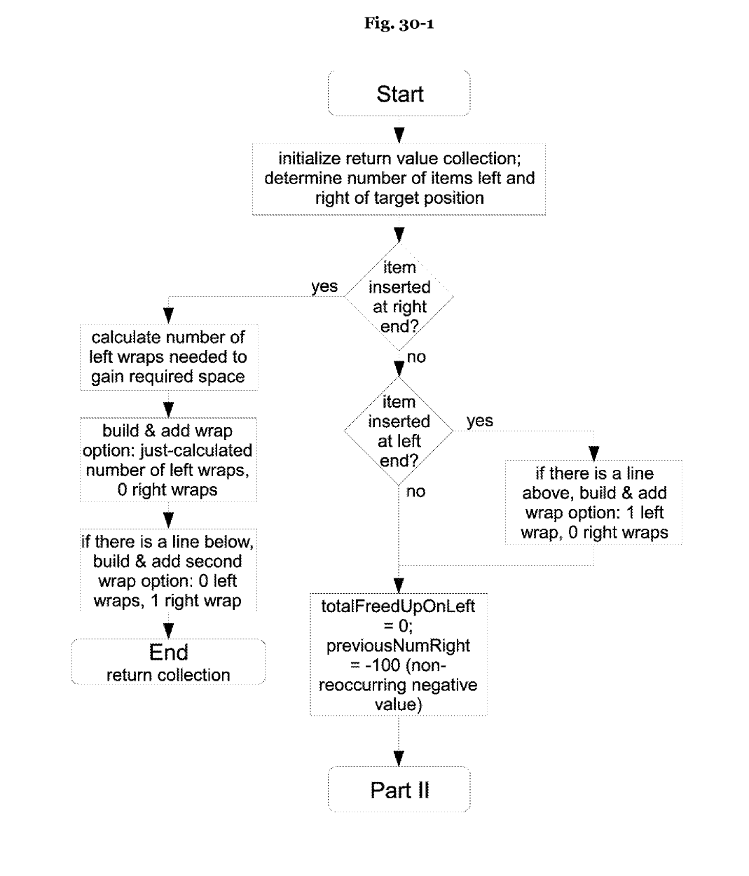

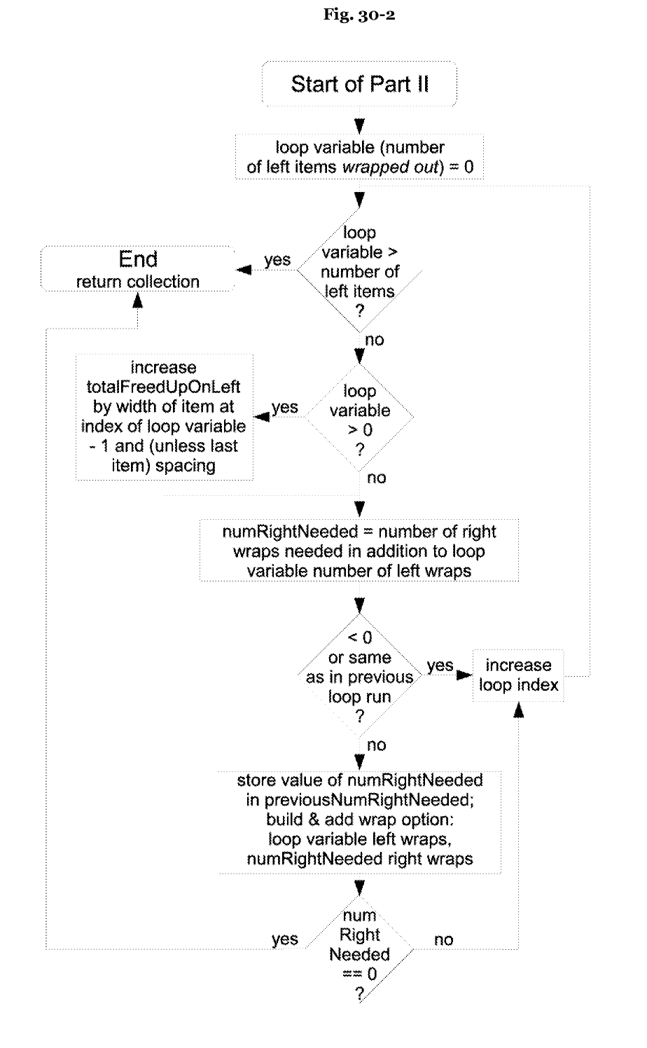

FIGS. 30-1 and 30-2 show exemplary flowcharts for building a collection of wrap options, whereby FIG. 30-1 contains the first part of the flowchart and FIG. 30-2 contains the second part. At the outset, a return value collection is initialized. Also, the numbers of items presently found to the left and to the right of the target position must be identified. If the item is inserted at the right end of the target line, the items that can be wrapped out of the target line to free up space are found only on the left side. Accordingly, the number of left wraps capable of freeing up the required space is determined. A wrap option is built by setting the number of left wraps to the just-determined number and by setting the number of right wraps to zero. That wrap option is added to the results collection. Provided that there is a line below (i.e., the line index is not the highest index), a second wrap option consisting of zero left wraps and one right wrap (i.e., the item to be inserted) is built and is added to the results collection. With one or two wrap options in the results collection, the process of building all options is complete.

If the new item is inserted at the left end, a first wrap option is built and added to the results collection. That first wrap option consists of one left wrap (i.e., the item to be inserted) and zero right wraps. In any event, the operation continues by initializing the values for totalFreedUpOnLeft (aggregate space gain left of insertion position), previousNumRight (number of right wraps identified during last loop run), and (at the start of Part II of the second part of the flowchart, FIG. 30-2) setting the loop variable (which represents the number of items to be wrapped out on the left side) to zero. If the loop variable exceeds the number of items left of the insertion position, the process is complete and the results collection is returned. Otherwise the process continues. If the loop variable is greater than 0, the totalFreedUpOnLeft value is increased by the width of the item at an index that is one less than the loop index and, unless this is the last item processed on the relevant side, one item-to-item spacing. The number of right wraps needed in addition to the number of left wraps contained in the loop variable is calculated in accordance with the previously-described process (FIG. 29) and stored in numRightNeeded. If the determination of complementary wraps communicates (in the example, and without limitation, by means of a particular negative value other than, in the example, −100, which should be the initial but also a non-reoccurring value of previousNumRight) that no number of right wraps would be sufficient or if the number of right wraps needed is identical to the one identified in the previous loop run (in which case it would be a waste of resources to wrap out more items on the left side if this does not reduce the number of wraps needed on the right side), the loop continues immediately with the next item (without building and adding another wrap option). Otherwise, the new wrap option is built by using the value of the loop variable as the number of left wraps and the value of numRightNeeded as the number of right wraps. The value of numRightNeeded is furthermore stored in previousNumRightNeeded to allow the next loop run to identify a scenario in which a greater number of left wraps does not result in a lower number of right wraps (i.e., the option is less efficient than a previous one). If the number of right wraps needed is zero, the results collection can be returned and the process is complete as well.

A person skilled in the art knows how to optionally restructure the order in which the wrap options are determined by identifying the number of left wraps needed in addition to a given number of right wraps, in which case the process can be cut short if the item is inserted at the left end. All other things being equal, the resulting list of wrap options would be the same.

After the collection of wrap options has been built, an evaluation of the technical impact of each wrap option is performed. The determination of the most efficient option is reached by comparing the values in the evaluation results objects to each other. Different embodiments of the invention may set different priorities or place different weight on different impact indicators (if values are multiplied with a weighting factor).

One suitable indicator is the total number of lines used. If a line was previously empty but would contain at least one item as a result of the wrapping operation, and if that line represents a new outermost line among the lines containing items, less efficient use of screen space is made than if that line remains empty. If the previously-empty line has an index of X and no line with an index below X contains any item, there would be a new outermost line in the event of a left-wrap (i.e., items are wrapped from a lower line into an upper line). If the previously-empty line has an index of X and no line with an index above X contains any item, there would be a new outermost line in the event of a right-wrap (i.e., items are wrapped from an upper line into a lower line). In addition to other considerations, it is also a recommended design goal for usability reasons to minimize the distance between the topmost and the bottommost snap lines unless the user deliberately chooses to insert items into previously-empty, new outermost lines.

Another suitable indicator is the total number of lines affected by wrapping operations. This number can be counted during the evaluation process, or a flag can be set for each line affected or the number of each line affected can be added to a collection (so as to avoid duplicate counting of a given line).

A further suitable indicator is the total number of items wrapped from one line to another. This is a particularly important criterion if the repositioning of items is visualized by means of animated graphics, and it is also a usability criterion since users will be less confused when seeing (with or without animated graphics) repositionings within a line than wrapping operations that move an item from one end of a first line to the opposite end of another line.

Yet another suitable indicator is the total distance of all repositionings of items, whereby there are different choices for how to account for wrapping operations (by way of example, and without limitation, wrapping operations could be given additional weight by treating them as a substantially greater distance than any repositioning of an item within the same line).

It is only a matter of internal program code organization whether the evaluation of wrapping operations also returns all or some of the data (besides the numbers of left and right wraps, which identify a wrap option at the highest level) needed for the graphical operations to be performed if a particular wrap option is chosen.

The comparison of the different results of an evaluation could be based on strict priorities, in which case a first criterion would be evaluated and the result of the comparison of the values of two options relating to that first criterion would be the result of the overall comparison, unless there is no difference, in which case a second criterion would be evaluated (and so forth). It could also be based on a weighted indicator. For example, if a new outermost line results from a wrapping operation, it could be assigned a value of three times the maximum value of repositionings of items within a given line, while repositionings of items within lines may increase the impact indicator by only half the distance of the related item movements.

### Repositioning and Wrapping of Items in a Snap Grid

The repositioning and wrapping operations, including the determination of the optimal wrapping strategy, disclosed with respect to snap lines containing variable-width items are simplified in connection with a snap grid.

While a two-dimensional snap grid has lines and columns in graphical terms, the grid cells can be internally indexed without the index in and of itself reflecting the two-dimensional appearance of the grid (for which it is sufficient to calculate the coordinates of each grid cell in accordance with techniques known to a person skilled in the art).

If an item is inserted into a grid cell X that contains an item, the item previously in grid cell X can be moved to the right by inserting it into grid cell X+1 (and if grid cell X+1 contains an item, it is placed into grid cell X+2, and so forth), or it can be moved to the left by inserting it into cell X−1 (and if grid cell X−1 contains an item, it is placed into grid cell X−2, and so forth).

For determination of the optimal wrapping strategy, it is possible to find, by means of a loop decreasing or increasing a loop index starting with a cell adjacent to the target position, the closest index of an empty cell. The lesser the difference between the index of the target cell and the index of the closest empty cell, the fewer items have to be repositioned if the related direction (left or right) is chosen. For a one-dimensional snap grid, this is the only suitable criterion.

For a two-dimensional snap grid, it is additionally or alternatively possible to count the number of lines affected by a wrapping operation, or the number of new outermost lines used, by adapting the optimization technique described further above in connection with snap lines. Certain shortcuts are enabled by the specific nature of a snap grid. For example, the number of lines affected (or a correlating value that would also be a suitable indicator) can be derived from the difference in Y coordinates between the target cell for the insertion and the furthest cell affected by the operation (i.e., the cell that is both adjacent to the closest empty cell and closer to the target cell than the closest empty cell is). The determination of whether a line of a snap grid is empty or not can be made more efficient by maintaining a collection in which each object represents a line and contains the range of indices of all cells in that line. Additionally or alternatively, each object representing a cell can contain a line index.

### Quantifying Knowledge of Item Relationships

The item relationships the present invention is primarily concerned with include
the membership of an item in a particular item group (for example, the fact that certain mountains are located in one country while certain other mountains are located in another country),
the order of a plurality of items by a given criterion (for example, the order of multiple political office-holders by the date of their initial appointment), and
combinations thereof (for example, the grouping of mountains by country combined with an ordering of the mountains in each country by elevation).

In most cases, item memberships in groups are single data points. For example, most rivers are located in only one country, and politicians can be members of only one political party at a given point in time. However, certain rivers (such as the Nile and the Rhine) are shared by a plurality of countries, and throughout an entire career, a politician may be a member of a plurality of parties (for example, Ronald Reagan was a member of the Democratic Party before joining the Republican Party in 1962). Similarly, one of the first 44 presidents of the United States, Grover Cleveland, served two non-consecutive terms and therefore constitutes the 22nd as well as the 24th president of the United States, while the other 43 presidents appear only once on a numbered list of presidents.

A person skilled in the art knows how to internally represent such relationships in different data formats. An item can be a member of a plurality of groups if each group constitutes a collection of items as long as there is no requirement that a data point of the item itself define one (and only one) group the item belongs to. Additionally or alternatively, each item may contain a collection of groups or group IDs in order to have room for multiple group memberships (or multiple ranks on an ordered list) per item.

On the display, items are represented by movable graphical objects. At least in scenarios in which no item is a member of more than one group or occurs more than once on an ordered list, it is a valid option that data structures may be associated with movable graphical objects by simply storing all of the data relating to the item itself (such as the name of a politician or mountain, with or without additional data) in the same object as the movable graphical object representing the item vis-à-vis the user. However, such arrangement of data would be inconsistent with the widely-adopted Model-View-Controller architectural pattern and would result in certain inefficiencies. For example, the lifecycles of data items and their corresponding graphical objects typically differ, suggesting that usually small data items should be kept separate from potentially memory-consuming graphical objects.

In certain preferred embodiments, each movable graphical object contains one data point linking a data item to the movable graphical object, typically (by way of example and without limitation) an item ID or a pointer to the location in which the item data is stored in memory.

A person skilled in the art implementing the invention can choose whether to implement movable graphical objects from scratch with known techniques or to make use of widely-available operating system functionality. Operating systems with graphical user interface layers typically provide controls (user interface elements) that detect some or all drag-and-drop actions by the user and can be repositioned by merely changing their coordinates before refreshing the display.

While embodiments of the invention can achieve the relatively highest level of performance if the movable and any non-movable graphical objects have a rectangular shape, the invention is not limited to any particular shape. For example, by using a transparent color, items may have a rectangular shape for internal purposes while appearing to the user to be arbitrarily-shaped. In this case, the invention delivers the same level of performance as in the case of visibly-rectangular shapes and is capable of performing the same optimization of any repositionings of items. Alternatively, arbitrary shapes can be supported by defining graphical objects as polygons. Algorithms for identifying intersections of items with polygons (including elliptic shapes, which are effectively polygons with large numbers of vertices) and locations of points relative to a polygon are known. Certain algorithms triangulate polygons, i.e., break polygons up into groups of triangles. Polygons can also be represented as groups of rectangles.

Relationships between items as well as between items and groups can be visually represented in different forms. It is common to place all (actual or presumed) members of an item group in a framed area, for example, a rectangular box, and to represent the order of items through the one-dimensional or two-dimensional positioning of such items relative to each other.

### Scoring Techniques

### Comparison of Grouping Input Against Correct Grouping

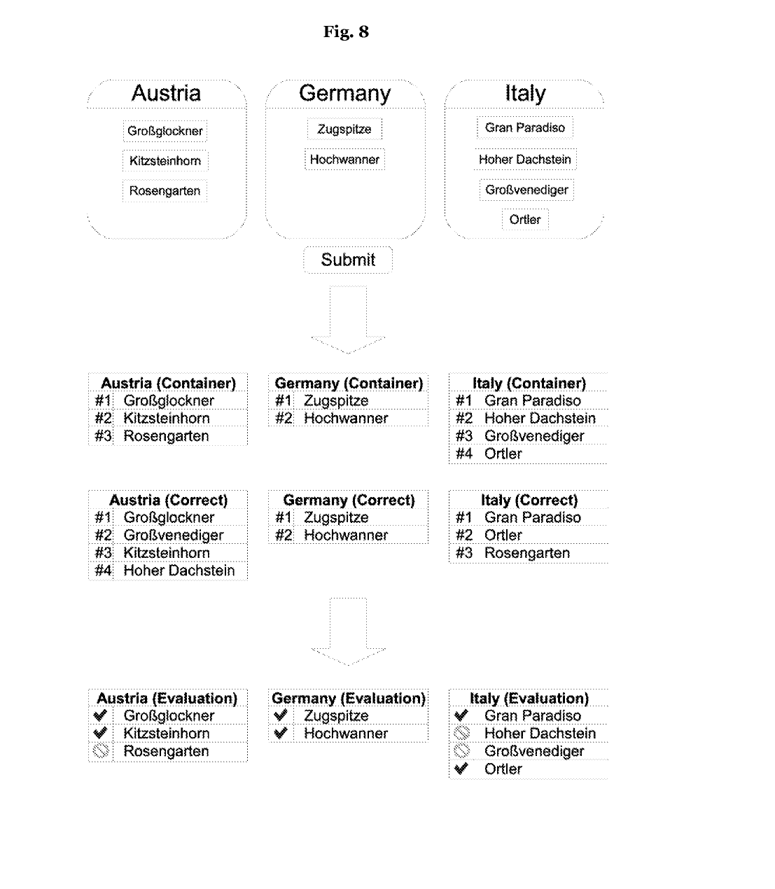

In order to quantify the user's knowledge of the group membership of items, it is necessary to compare the user's presumed composition of groups against a predefined correct grouping. FIG. 8 shows an example in which it is known that the user meant the first group (“Groβglockner”, “Kitzsteinhorn”, “Rosengarten”) to contain mountains located in Austria, the second group (“Zugspitze”, “Hochwanner”) to contain mountains located in Germany, and the third group (“Gran Paradiso”, “Hoher Dachstein”, “Groβvenediger”, “Ortler”) to contain mountains located in Italy.

This is undoubtedly the case if the user placed the items in containers with the respective labeling (as depicted in FIG. 8), or if the user was instructed to place items in containers defined by location and/or size (for example, if the user was asked to place all Austrian mountains in the leftmost container). Otherwise some further analysis of the user's intent, as explained below, may be required.

In FIG. 8, the comparison of the groups formed by the user against the correct groups shows that the user correctly identified both German mountains and correctly identified two Austrian as well as two Italian mountains, but erroneously deemed an Italian mountain (“Rosengarten”) to be an Austrian mountain and assigned two Austrian mountains (“Hoher Dachstein”, “Groβvenediger”) to Italy.

A strictly binary and coarse determination would result in a zero score because the user failed to correctly group all items.

Some alternative evaluations according to embodiments of the invention would count all correct assignments and award points for them; count all incorrect assignments and deduct points from a maximum achievable score; or award points based on the number by which the number of correct assignments exceeds the number of incorrect assignments.

### Differentiated Scoring of Grouping Input

FIG. 9 shows an example of a more differentiated scoring of the same grouping input as in FIG. 8. The more differentiated scoring has an item-specific difficulty level. The difficulty level could also be the same for all items in a group. That difficulty level determines the number of points in which a correct assignment results (in the example, the number of points is identical to the difficulty level, but it could also be proportional to it or be read from a table of difficulty levels and points). In the example it also determines the number of points deducted for an incorrect assignment. In the example, the number of points deducted is greater if the difficulty level is higher: the incorrect assignment of “Hoher Dachstein” to Italy, instead of Austria, results in a deduction of only two points because the difficulty level was high (6), while the incorrect assignment of “Groβvenediger”, which has a lower difficulty level attached to it, is penalized with a deduction of five points. Again, the relationship could be numerical (for example, 8 minus the difficulty level) or the number of points to be deducted could be read from a table.) As stated above, scoring can be based on only correct assignments, on only incorrect assignments, or on a combination as in FIG. 9.

### Assignment of Object to Container in Non-Snapping Setup

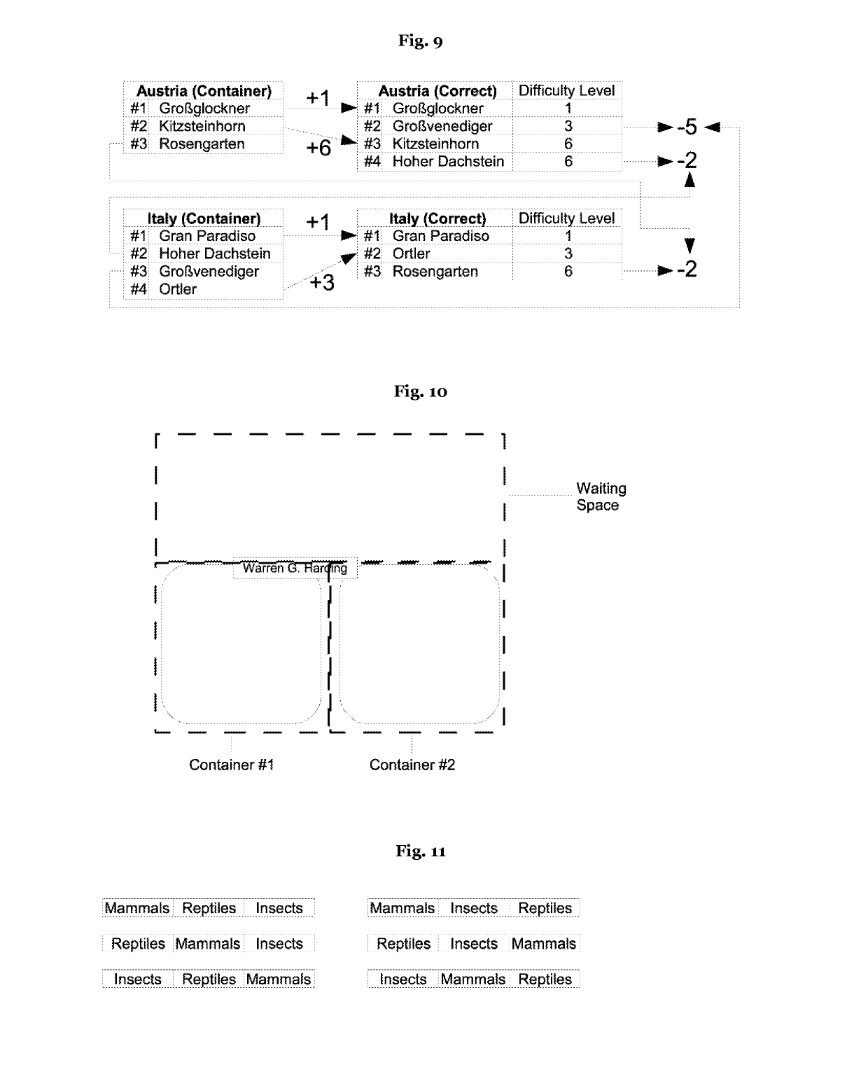

If a container has a snap grid or snap lines, the content of the container (in terms of which movable graphical objects, each of which his associated with a data item relevant to knowledge quantification) is updated after each dropping of an object on the container. In the event of a non-snapping container, such determination can wait until the user submits a grouping for evaluation. FIG. 10 shows an exemplary assignment of an item to a container (Container #1). The item is placed in an arbitrary (non-snapping) location where it has overlaps with a waiting space and with two containers. Since the area of the overlap with Container #1 is greater than with that of Container #2 or that of the waiting space, the item would be deemed to have been placed in Container #1.

It is also possible in embodiments of the invention to allow intentionally-ambiguous placements. For example, the user might actually want to position an item corresponding to Mont Blanc in a place where it touches both the container for Switzerland and the container for Italy (the mountain belongs to both countries, and ownership of its highest elevation is disputed). There can, but need not, be a threshold for a percentage of the area covered by the movable graphical object that must overlap with each of a plurality of containers in order for the item to be deemed to be placed in both containers simultaneously. Also, there could also be two movable graphical objects relating to Mont Blanc, and the user could place one in the Italy container and the other in the Switzerland container.

Categorization of Item Groups from Unlabeled Containers

If containers (such as the exemplary ones in FIG. 2-1) are not labeled and if the correct group of items relating to a container is not defined by the location and/or size and/or color and/or other visual characteristic of the container, the knowledge quantification system needs to perform an intermediate step (between submission of an answer for evaluation and the actual scoring) of determining, i.e. “understanding”, the user's intended grouping by comparing the user-formed groups to the correct groups.

It is recommended to view the user's intended grouping in the light most favorable to the user. For example, if the user formed a first group consisting of three Austrian mountains and one Italian mountain and a second group consisting of two Italian mountains and one Austrian mountain, the user likely intended the first group to correspond to Austria and the second one to correspond to Italy.

Depending on the details of the scoring algorithm and on design decisions, an effort to view the user's input in the most favorable light may either involve a complete scoring of all permutations or a simpler evaluation, such as a count of correct assignments. Once a collection of permutations has been built, algorithms known to a person skilled in the art can evaluate each permutation and determine the permutation most favorable to the user. The most favorable permutation will then be the (sole) basis for scoring.

FIG. 11 shows the six possible permutations of three groups. If the user formed three groups, and there are three correct groups (in the example, “Mammals”, “Reptiles”, and “Insects”), any permutation could be the user's intended grouping.

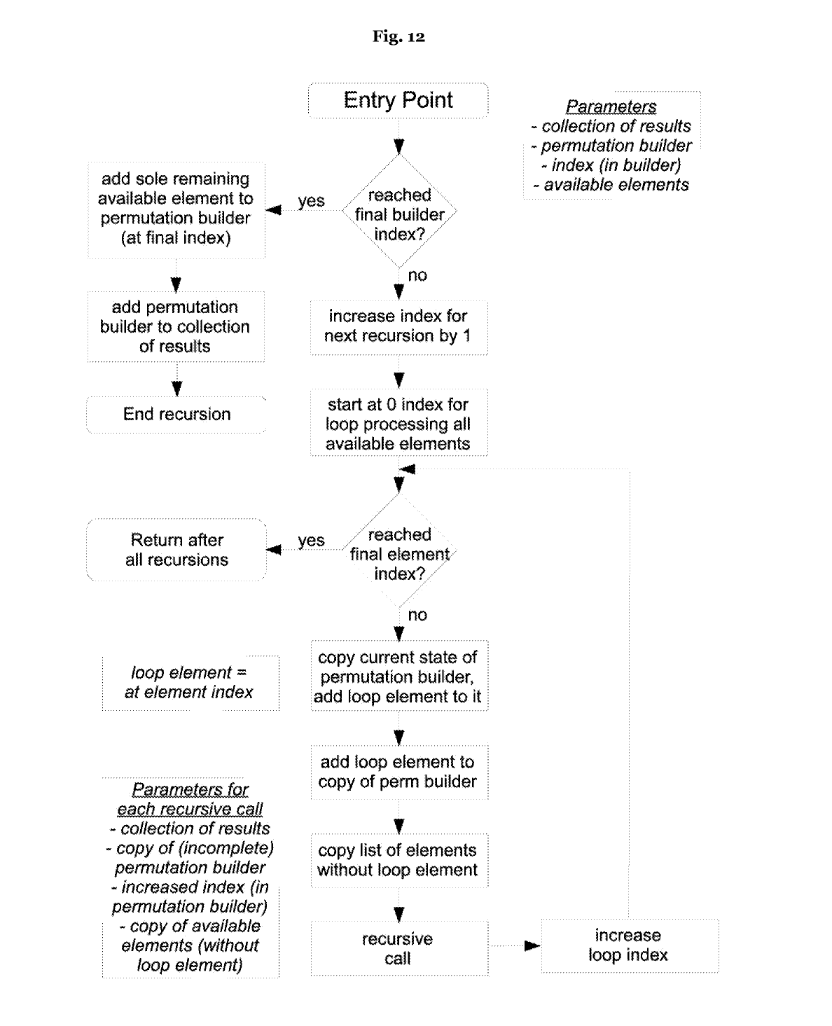

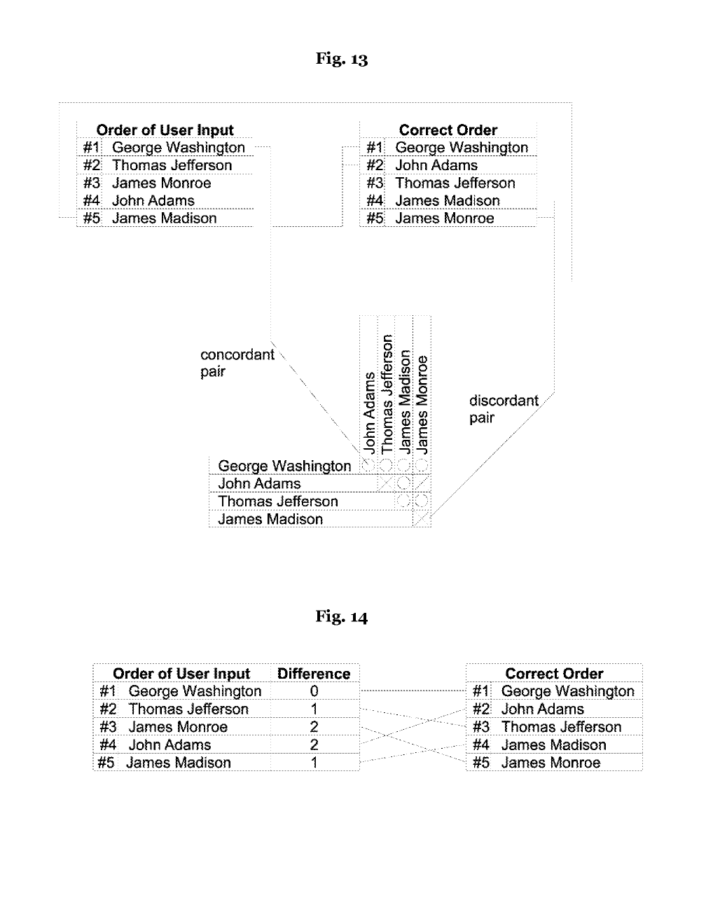

FIG. 12 is an exemplary flowchart of a recursive algorithm for generating a collection of all permutations in accordance with embodiments of the invention. The recursive function is called with four parameters: a collection of results (initially empty), a permutation builder (i.e., an object to which group IDs (alternatively, pointers to the groups) are added successively until a complete permutation has been built), an index within the builder (i.e., the zero-based index of where the next addition of an item to the permutation builder will occur), and a collection of available elements (i.e., group IDs available at this level of the recursive process for addition to the current permutation builder). Recursion ends when the final permutation builder index is reached, which is checked at the outset of the recursive function. In that event, there will be only one more available element (group ID) remaining, which is added to the current permutation builder, which in turn is added to the collection of results. No further recursive call is made at this juncture. If the final index has not been reached yet, a recursive call must be made for each of the available elements (group IDs). Inside the loop performing these calls, the current state of the permutation builder must be copied because further down the recursion path different additions will be made. For each recursive call, a copy of the list of available elements is provided after removing from that copy the element that was just added inside the loop.

### Comparison of Ordering Input Against Correct Order of Items

If the items to be ordered by the user are placed in a container or work space with snapping functionality, the order determined by the user is unambiguously identifiable and available for further evaluation at submission time. Otherwise the intended order must be identified (as discussed further below).

FIG. 13 shows an exemplary comparison of a user-determined order of items against the predefined correct order by means of computing the Kendall tau distance. In the example, the names of the first five presidents of the United States are ordered by the beginning of their first term. The Kendall tau distance is the number of discordant pairs, i.e., pairs of items that appear in the opposite order on one list as they do in the other. In the example, there are ten pairs in total. The total number of pairs of X number of items is always X(X−1)/2. In the example, seven of the pairs are concordant (the relative ranking of those items is identical on both lists) and three (John Adams-Thomas Jefferson; John Adams-James Monroe; and James Madison-James Monroe) are discordant. In absolute numbers, the Kendall tau distance in the example is 3. This absolute number can be normalized by dividing it by the total number of pairs, in which case 1 (or 100%) means that all pairs are discordant and 0 means that all pairs are concordant. In the example, the normalized Kendall tau distance amounts to 3/10=0.3 (or 30%). The knowledge quantification system can, for example, award a number of points that decreases with each discordant pair. It can also award points based on the difference between concordant and discordant pairs.

The following sample code written in the C# programming language for Microsoft Windows demonstrates (at the highest level) how to determine the Kendall tau distance:

```
private int GetKendallTauDistance( )
{
    int returnValue = 0;
    int highestCorrItemIndex = correctlyGroupedItems.Count − 1;
    for(int i = 0; i <= highestCorrItemIndex − 1; i++)
    {
      ItemWithIndexAndGroupId itemOuterLoop =
          correctlyGroupedItems[i];
      for (int j = i + 1; j <= highestCorrItemIndex; j++)
      {
          ItemWithIndexAndGroupId itemInnerLoop =
            correctlyGroupedItems[j];
          if (CheckIfDiscordantPair(itemOuterLoop,
            itemInnerLoop))
          {
            returnValue++;
          }
      }
    }
    return returnValue;
}
private Boolean CheckIfDiscordantPair(
    ItemWithIndexAndGroupId item1, ItemWithIndexAndGroupId item2)
{
    int userPosItem1 = GetUserPositionOfItem(item1);
    int userPosItem2 = GetUserPositionOfItem(item2);
    int corrPosItem1 = GetCorrPositionOfItem(item1);
    int corrPosItem2 = GetCorrPositionOfItem(item2);
    if (userPosItem1 < userPosItem2)
    {
      return (corrPosItem1 > corrPosItem2);
    }
    return (corrPosItem1 < corrPosItem2);
}
```

The GetKendallTauDistance function creates all pairs: every time the inner part of the inner loop is executed, the values of itemOuterLoop and itemInnerLoop represent one pair. The CheckIfDiscordantPair subroutine then retrieves the ranks (i.e., indices) of both items on the user-determined list (GetUserPositionOfItem) as well as on the predefined correct list (GetCorrPositionOfItem). If the first item appears on the user-determined list before the second item, the pair is found concordant if the opposite is the case on the correct model-answer list; otherwise it is a concordant pair and the result is “false”. Since two items on a list cannot have an identical rank, it is certain that if the first “if” condition in CheckIfDiscordantPair is not met, the first item appears after the second item on the user-determined list, in which case the pair is discordant if the first item appears before the second one on the model-answer list.

While the Kendall tau distance is the preferred measure for knowledge quantification relating to the order of a set of items, alternative algorithms are possible in embodiments of the invention. For example, a knowledge quantification system could focus its analysis on the ranks of one item at a time as opposed to pairs of items. FIG. 14 shows that, in the example, the first item (George Washington) has the correct rank, while the other four items have a false rank, with the difference between the correct and the user-determined rank being 1 each for Thomas Jefferson and James Madison, and 2 each for James Monroe and John Adams.

### Identification of User-Determined Order of Items in Non-Snapping Setup

If the items to be ordered by the user are placed in a container or work space with snapping functionality, the order determined by the user is unambiguously identifiable and available for further evaluation at submission time. Otherwise the intended order must be identified as discussed in this section.

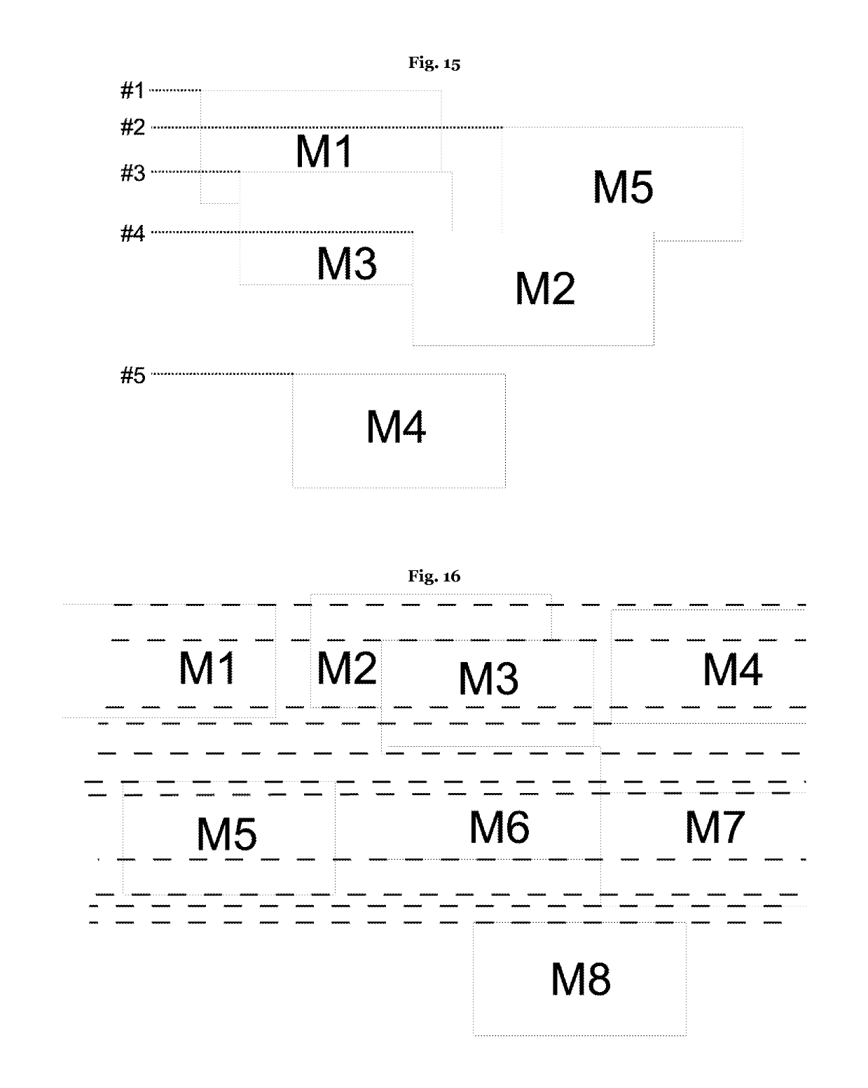

If a user is requested to order items one-dimensionally (i.e., vertically or horizontally), the user's intended order can be discerned based on the order of the relevant coordinate. FIG. 15 shows an exemplary identification of a vertical order of items based on the topmost Y coordinates of the items. In the example, each item has a unique top Y coordinate. If two or more items had the same topmost Y coordinate, their order relative to each other could either be determined based on a second criterion (for example, the X coordinate) or the user could be requested to provide clarity by repositioning items or otherwise indicating their intended order (for example, by touching or clicking on buttons representing answer to questions concerning ambiguities in the order of items).

On many displays, a two-dimensional ordering of items makes more efficient use of the available screen space. However, identification of a user-determined two-dimensional order of items based on arbitrarily-determined item positions requires, as a first step, the identification of rows. Thereafter, the relative position of items in a row can be determined in accordance with the above-described method of identifying a user-determined one-dimensional order by evaluating only the relevant coordinate (which for multiple items in a given row is the X coordinate).

FIG. 16 shows an exemplary arrangement of items (M1 to M8) whereby the dashed lines are the extended top and bottom lines of certain items. It is clear that the user intended items M1, M2, M3 and M4 to form the first row; items M5, M6 and M7 to form the second row; and M8 to be the only item in the third row. A programmable electronic device can discern these intended rows by beginning with the topmost item, which is M2 in the example and which is by definition a member of the first (topmost) row. The question is then which other items are in the same row as M2. M1 and M4 are particularly clear cases because their Y coordinate ranges (top to bottom) overlap for the largest part with that of M2. The Y coordinate range of M3 overlaps with that of M2 to a lesser degree, but still more than 50% of the Y coordinate range of M3 falls within that of M2, while the only item that has a Y coordinate range overlap with M3 besides those that are unambiguously in the first row (M1, M2, M4) is M6, which has only a marginal overlap of its Y coordinate range with that of M3 and no overlap whatsoever with any of the three items that are undoubtedly in the first row (M1, M2, M4). It is a recommended requirement that all items deemed to be in the same row have a significant Y range overlap with each other, as do M1, M2, M3 and M4 in the example. There is no single threshold value that must inevitably be applied, but the shared part of the Y coordinate ranges of all items in a row should typically amount to at least 40%, possibly 50% or more, of the Y coordinate range of each item in that row. In the example, that is also the case for M5, M6 and M7 (second row). M8 is dearly isolated and represents a row of its own.

It would be possible at submission time to request the user to disambiguate the arrangement of items by repositioning them or by answering questions (such as by touching or clicking on buttons representing answers).

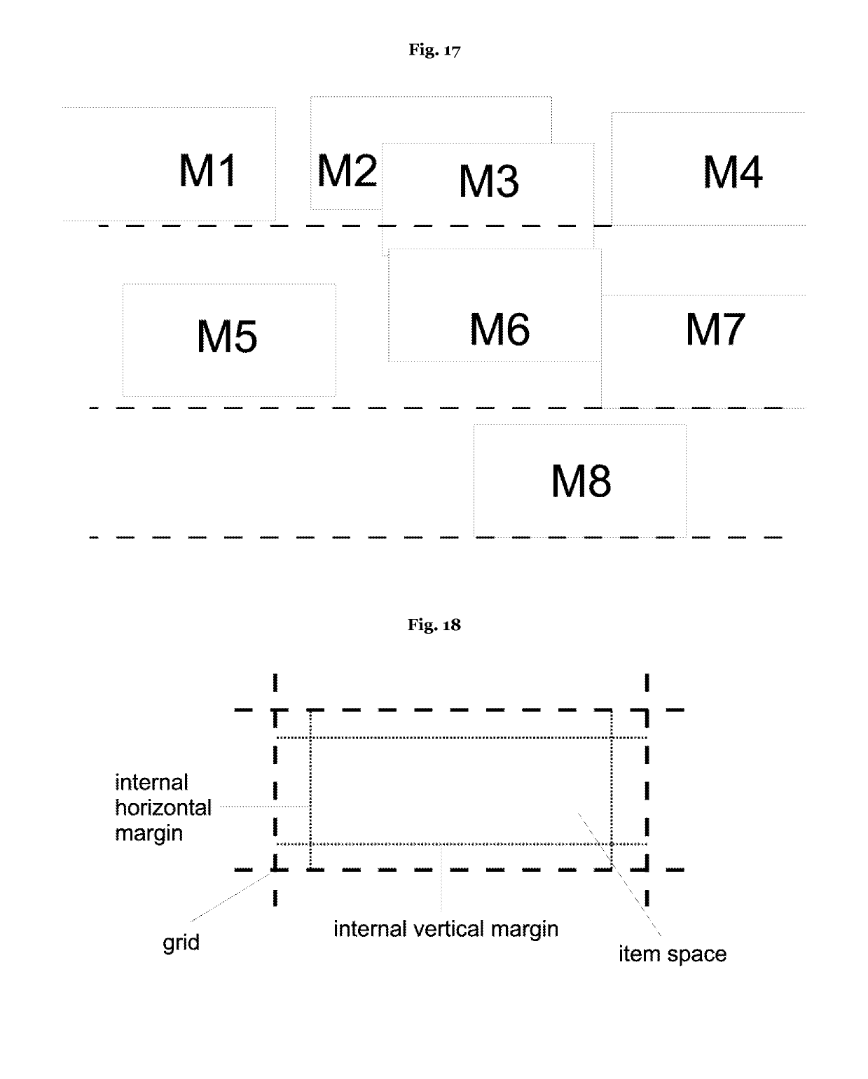

However, the preferred way to avoid ambiguities is to provide visual feedback to the user's arrangement of items so as to indicate the order of items as identified by the programmable electronic device at a given point in time. FIG. 17 shows an exemplary visualization (by means of dashed lines) of identified rows. In the example, the row to indicate the first (topmost) line (M1, M2, M3, and M4) is the (horizontally-extended) bottom line of M4, which has the lowest bottom line of those four items that does not touch any item from a lower line (in this case, M6). The (horizontally-extended) bottom line of M7 is the lowest bottom line of all items in the second row and at the same time the lowest one that does not touch any item from a lower line (in this case, M8).

Alternatively or additionally to lines drawn to indicate the rows identified by the programmable electronic device based on the user's arrangement of items, the items could also be numbered in the order identified. The identified rank of each item could be displayed on that item, next to that item, or partly overlap it.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, executed by at least one computer for processing drag-and-drop gestures on a user interface, the method comprising:
a. displaying a plurality of graphical objects on the user interface, at least two of said graphical objects each being associated with a data structure, at least two of said data structures being associated with a model answer of an automated knowledge quantification system;
b. detecting a drag-and-drop gesture on the user interface indicating that a first one of the plurality of graphical objects is moved to a line comprising at least one second graphical object of the plurality of graphical objects;
c. determining that the horizontal position of the first graphical object is in conflict with the at least one second graphical object; and
d. calculating movement instructions to move the at least one second graphical object to the left to create sufficient space for the first graphical object.

2. The method of claim 1, wherein step d. further comprises moving at least third graphical object of the plurality of graphical objects to the right to create sufficient space for the first graphical object.

3. A non-transitory computer-readable medium storing a program executable by a computer to perform instructions for implementing a method in accordance with claim 1.

4. The method of claim 1, wherein the user interface is displayed on a touch-sensitive display of a portable electronic device.

5. The method of claim 1, comprising the step of simulating a plurality of alternative graphical object repositioning strategies prior to the repositioning of a graphical object; and
determining a most efficient graphical object repositioning strategy.

6. A computer-implemented method, executed by at least one computer for processing drag-and-drop gestures on a user interface, the method comprising:
a. displaying a plurality of graphical objects on the user interface, at least two of said graphical objects each being associated with a data structure, at least two of said data structures being associated with a model answer of an automated knowledge quantification system;
b. detecting a drag-and-drop gesture on the user interface indicating that a first one of the plurality of graphical objects is moved to a line comprising at least one second graphical object of the plurality of graphical objects;
c. determining that the horizontal position of the first graphical object is in conflict with the at least one second graphical object; and
d. moving at least the left-most graphical object on the line to an overlying line to create sufficient space for the first graphical object.

7. The method of claim 6, further comprising the step of moving at least the right-most graphical object on the line to an underlying line to create sufficient space for the first graphical object.

8. The method of claim 6, wherein the moving of at least the left-most and/or right-most graphical object is performed iteratively for the respective object on the overlying and/or underlying line.

9. The method of claim 7, wherein the moving of at least the left-most and/or right-most graphical object is performed iteratively for the respective object on the overlying and/or underlying line.

10. The method of claim 6, comprising the step of simulating a plurality of alternative graphical object repositioning strategies prior to the repositioning of a graphical object; and
determining a most efficient graphical object repositioning strategy.

11. The method of claim 10, wherein the step of determining a most efficient graphical object repositioning strategy comprises determining whether a new line has to be created.

12. The method of claim 11, wherein the step of determining a most efficient graphical object repositioning strategy comprises determining the total number of affected lines.

13. The method of claim 10, wherein the step of determining a most efficient graphical object repositioning strategy comprises determining the total number of graphical objects that have to be moved from one line to another.

14. The method of claim 10, wherein the step of determining a most efficient graphical object repositioning strategy comprises determining the total distance of all needed graphical object repositionings.

15. The method of claim 6, wherein the user interface is displayed on a touch-sensitive display of a portable electronic device.

16. A non-transitory computer-readable medium storing a computer program executable by a computer to perform instructions for implementing a method in accordance with claim 3.

17. A portable electronic device, comprising:
a. a touch-sensitive display;
b. a display module configured for instructing the touch-sensitive display to present a plurality of graphical objects on a user interface, at least two of said graphical objects each being associated with a data structure, at least two of said data structures being associated with a model answer of an automated knowledge quantification system; and
c. at least one processor;
d. a module configured for executing on the at least one processor instructions for:
detecting a drag-and-drop gesture on the user interface indicating that a first one of the plurality of graphical objects is moved to a line comprising at least one second graphical object of the plurality of graphical objects;
determining that the horizontal position of the first graphical object is in conflict with the at least one second graphical object; and
calculating movement instructions to move the at least one second graphical object to the left to create sufficient space for the first graphical object.

18. The portable electronic device of claim 17, wherein the processor is further configured for simulating a plurality of alternative graphical object repositioning strategies prior to the repositioning of a graphical object; and
determining a most efficient graphical object repositioning strategy.

19. A portable electronic device, comprising:
a. a touch-sensitive display;
b. a module display configured for instructing the touch-sensitive display to present a plurality of graphical objects on a user interface, at least two of said graphical objects each being associated with a data structure, at least two of said data structures being associated with a model answer of an automated knowledge quantification system; and
c. a processor;
d. a module configured for executing on at least one processor instructions for:
detecting a drag-and-drop gesture on the user interface indicating that a first one of the plurality of graphical objects is moved to a line comprising at least one second graphical object of the plurality of graphical objects;
determining that the horizontal position of the first graphical object is in conflict with the at least one second graphical object; and
calculating movement instructions to move at least the left-most graphical object on the line to an overlying line to create sufficient space for the first graphical object.

20. The portable electronic device of claim 19, wherein the processor is further configured for simulating a plurality of alternative graphical object repositioning strategies prior to the repositioning of a graphical object; and
determining a most efficient graphical object repositioning strategy.
